(19) United States
(12) Patent Application Publication
(10) Pub. No.: US 2013/0192868 A1
(43) Pub. Date: Aug. 1, 2013

(54) Faceplate Assemblies For Securing Connectivity

(71) Applicant: Panduit Corp., Tinley Park, IL (US)

(72) Inventors: Robert E. Fransen, Tinley Park, IL (US); Jeremy S. Parrish, Frankfort, IL (US)

(73) Assignee: PANDUIT CORP., Tinley Park, IL (US)

(21) Appl. No.: 13/752,573

(22) Filed: Jan. 29, 2013

Related U.S. Application Data
(60) Provisional application No. 61/592,286, filed on Jan. 30, 2012.

(51) Int. Cl. H02G 3/10

(52) U.S. Cl. CPC H02G 3/10
USPC 174/66

(57) ABSTRACT

The present invention is directed to a faceplate assembly. The faceplate assembly includes a backing plate and a plurality of cover plates that mount to the backing plate. The baking plate has an opening that receives at least six modules. Each cover plate includes a center opening corresponding to the modules received in the backing plate.

### CROSS REFERENCE TO RELATED APPLICATION

This application claims priority to U.S. Provisional Application No. 61/592,286, filed Jan. 30, 2012, the subject matter of which is hereby incorporated by reference in its entirety.

### BACKGROUND

This invention relates to faceplate assemblies for securing connectivity and, more particularly, to faceplate assemblies for securing connectivity that have appealing aesthetics, concealed hardware and concealed labeling.

### SUMMARY OF THE INVENTION

The present invention is directed towards a faceplate assembly having a backing plate and a plurality of cover plates that are mounted to the backing plate. The backing plate has an opening for receiving a plurality of modules. Each cover plate has centered openings corresponding to a unique quantity of the modules received in the backing plate.

The present invention is also directed towards a faceplate assembly with a backing plate, a plurality of inserts, a plurality of decorative plates, and a cover plate. The backing plate has an opening to receive the inserts. Each insert is configured to hold a different quantity of modules that are mountable to the backing plate. Each decorative plate includes at least one opening to expose the unique combination of the inserts. The cover plate also includes an opening to expose part of the decorative plate and the apertures of the modules that are held in the inserts. The cover plate and the decorative plate are mounted to the backing plate.

### BRIEF DESCRIPTION OF THE DRAWINGS

Certain embodiments of the present invention are illustrated by the accompanying figures. It should be understood that the figures are not necessarily to scale and that details that are not necessary for an understanding of the invention or that render other details difficult to perceive may be omitted. It should be understood, of course, that the invention is not necessarily limited to the particular embodiments illustrated herein.

FIG. 1 is a top front perspective view of an exemplary faceplate assembly coupled to a surface;

FIG. 2 is an exploded view of the faceplate assembly shown in FIG. 1, a networking jack, associated cable, and an electrical box are also shown;

FIG. 3 is a top front perspective view of a backing member and fasteners of the faceplate assembly shown in FIG. 1;

FIG. 4 is a top front perspective view of a cover of the faceplate assembly shown in FIG. 1;

FIG. 5 is a top rear perspective view of the cover shown in FIG. 4;

FIG. 6 is a top front perspective view of the faceplate assembly shown in FIG. 1 in an assembled condition with the backing member and fasteners shown in dashed lines;

FIG. 7 is a top rear perspective view of the faceplate assembly shown in FIG. 1, a networking jack and associated cable are also illustrated;

FIG. 8 is a top front perspective view of another exemplary cover of the faceplate assembly shown in FIG. 1;

FIG. 9 is a top rear perspective view of the cover shown in FIG. 8;

FIG. 10 is a top front perspective view of the faceplate assembly shown with the cover illustrated in FIG. 8, two networking jacks and associated cables are also shown and the backing member and fasteners are illustrated with dashed lines;

FIG. 11 is a top rear perspective view of the faceplate assembly, two networking jacks, and associated cables shown in FIG. 10;

FIG. 12 is a top front perspective view of a further exemplary cover of the faceplate assembly shown in FIG. 1;

FIG. 13 is a top rear perspective view of the cover shown in FIG. 12;

FIG. 14 is a top front perspective view of the faceplate assembly shown with the cover illustrated in FIG. 12, three networking jacks and associated cables are also shown and the backing member and fasteners are illustrated with dashed lines;

FIG. 15 is a top rear perspective view of the faceplate assembly, three networking jacks and associated cables shown in FIG. 14;

FIG. 16 is an exploded view of the faceplate assembly including still another exemplary cover, also shown are a surface, an electrical box, four networking jacks and associated cables;

FIG. 17 is a top front perspective view of the cover shown in FIG. 16;

FIG. 18 is a top rear perspective view of the cover shown in FIG. 16;

FIG. 19 is a top front perspective view of the faceplate assembly shown with the cover illustrated in FIG. 16, four networking jacks and associated cables are also shown and the backing member and fasteners are illustrated with dashed lines;

FIG. 20 is a top rear perspective view of the faceplate assembly, four networking jacks and associated cables shown in FIG. 19;

FIG. 21 is a top front perspective view of yet another exemplary cover of the faceplate assembly shown in FIG. 1;

FIG. 22 is a top rear perspective view of the cover shown in FIG. 21;

FIG. 23 is a top front perspective view of the faceplate assembly with the cover illustrated in FIG. 21, six networking jacks and associated cables are also shown and the backing member and fasteners are illustrated with dashed lines;

FIG. 24 is a top rear perspective view of the faceplate assembly, six networking jacks and associated cables shown in FIG. 23;

FIG. 25 is a top front perspective view of two faceplate assemblies coupled to a surface, and including different quantities of networking jacks and different covers, the two covers have their respective top edges substantially co-linearly aligned and have their respective bottom edges substantially co-linearly aligned;

FIG. 26 is a top front perspective view of another exemplary faceplate assembly coupled to a surface, the faceplate assembly includes an exemplary decorative member for accommodating a single networking jack;

FIG. 27 is an exploded view of the faceplate assembly shown in FIG. 26, a networking jack is also shown;

FIG. 28 is a rear perspective view of a cover and a decorative member of the faceplate assembly shown in FIG. 26;

FIG. 28A is an enlarged view of a portion of FIG. 28 showing a projection of the cover positioned in an aperture defined in the decorative member;

FIG. 28B is an enlarged view of a portion of FIG. 28 showing an exemplary manner of coupling the decorative member to the cover;

FIG. 29 is a top front perspective view of the exemplary faceplate assembly shown in FIG. 26, the faceplate assembly includes another exemplary decorative member for accommodating two networking jacks;

FIG. 30 is an exploded view of the faceplate assembly shown in FIG. 29, two networking jacks are also shown;

FIG. 31 is a top front perspective view of the exemplary faceplate assembly shown in FIG. 26, the faceplate assembly includes a further exemplary decorative member for accommodating three networking jacks;

FIG. 32 is an exploded view of the faceplate assembly shown in FIG. 31, three networking jacks are also shown;

FIG. 33 is a top front perspective view of the exemplary faceplate assembly shown in FIG. 26, the faceplate assembly includes still another exemplary decorative member for accommodating four networking jacks;

FIG. 34 is an exploded view of the faceplate assembly shown in FIG. 33, four networking jacks are also shown;

FIG. 35 is a top front perspective view of the exemplary faceplate assembly shown in FIG. 26, the faceplate assembly includes a yet another exemplary decorative member for accommodating five networking jacks;

FIG. 36 is an exploded view of the faceplate assembly shown in FIG. 35, five networking jacks are also shown;

FIG. 37 is a top front perspective view of the exemplary faceplate assembly shown in FIG. 26, the faceplate assembly includes still a further exemplary decorative member for accommodating six networking jacks;

FIG. 38 is an exploded view of the faceplate assembly shown in FIG. 37, six networking jacks are also shown;

FIG. 39 is a top front perspective view of the exemplary faceplate assembly shown in FIG. 26 coupled to a surface in a horizontal orientation, the faceplate assembly includes another exemplary decorative member for accommodating a single networking jack in a horizontal orientation;

FIG. 40 is an exploded view of the faceplate assembly shown in FIG. 39, a single networking jack is also shown;

FIG. 41 is a top front perspective view of the exemplary faceplate assembly shown in FIG. 26 coupled to a surface in a horizontal orientation, the faceplate assembly includes a further exemplary decorative member for accommodating two networking jacks in a horizontal orientation;

FIG. 42 is an exploded view of the faceplate assembly shown in FIG. 41, two networking jacks are also shown;

FIG. 43 is a top front perspective view of the exemplary faceplate assembly shown in FIG. 26 coupled to a surface in a horizontal orientation, the faceplate assembly includes still another exemplary decorative member for accommodating three networking jacks in a horizontal orientation;

FIG. 44 is an exploded view of the faceplate assembly shown in FIG. 43, three networking jacks are also shown;

FIG. 45 is a top front perspective view of the exemplary faceplate assembly shown in FIG. 26 coupled to a surface in a horizontal orientation, the faceplate assembly includes yet another exemplary decorative member for accommodating four networking jacks in a horizontal orientation;

FIG. 46 is an exploded view of the faceplate assembly shown in FIG. 45, four networking jacks are also shown;

FIG. 47 is a top front perspective view of a further exemplary faceplate assembly coupled to a surface, a single networking jack, a single plug, and associated plug cable are also illustrated;

FIG. 48 is an exploded view of the faceplate assembly shown in FIG. 47, a single networking jack, associated jack cable, and electrical box are also shown;

FIG. 49 is a top rear perspective view of an exemplary cover of the faceplate assembly shown in FIG. 47;

FIG. 50 is a top front perspective view of another exemplary backing member of the faceplate assembly shown in FIG. 47, the backing member is adapted to accommodate two networking jacks;

FIG. 51 is a top front perspective view of another exemplary cover of the faceplate assembly shown in FIG. 47, the cover is adapted to accommodate two networking jacks;

FIG. 52 is a top front perspective view of a faceplate assembly including the backing member and the cover shown in FIGS. 50 and 51, two networking jacks are also illustrated;

FIG. 53 is a top front perspective view of a further exemplary backing member of the faceplate assembly shown in FIG. 47, the backing member is adapted to accommodate three networking jacks;

FIG. 54 is a top front perspective view of a further exemplary cover of the faceplate assembly shown in FIG. 47, the cover is adapted to accommodate three networking jacks;

FIG. 55 is a top front perspective view of a faceplate assembly including the backing member and the cover shown in FIGS. 53 and 54, three networking jacks are also illustrated;

FIG. 56 is a top front perspective view of still another exemplary backing member of the faceplate assembly shown in FIG. 47, the backing member is adapted to accommodate four networking jacks;

FIG. 57 is a top front perspective view of still another exemplary cover of the faceplate assembly shown in FIG. 47, the cover is adapted to accommodate four networking jacks;

FIG. 58 is a top front perspective view of a faceplate assembly including the backing member and the cover shown in FIGS. 56 and 57, four networking jacks are also illustrated;

FIG. 59 is a top front perspective view of yet another exemplary backing member of the faceplate assembly shown in FIG. 47, the backing member is adapted to accommodate six networking jacks;

FIG. 60 is a top front perspective view of yet another exemplary cover of the faceplate assembly shown in FIG. 47, the cover is adapted to accommodate six networking jacks;

FIG. 61 is a top front perspective view of a faceplate assembly including the backing member and the cover shown in FIGS. 59 and 60, six networking jacks are also illustrated;

FIG. 62 is a top front perspective view of still another exemplary faceplate assembly, four networking jacks are also illustrated;

FIG. 63 is a top front perspective view of an exemplary cover of the faceplate assembly shown in FIG. 62;

FIG. 64 is a top front perspective view of an exemplary backing member of the faceplate assembly shown in FIG. 62;

FIG. 65 is a top front perspective view of yet another exemplary faceplate assembly, a single networking jack is also shown; and

FIG. 66 is a top front perspective view of an exemplary backing member of the faceplate assembly shown in FIG. 65.

Before any independent features and embodiments of the invention are explained in detail, it is to be understood that the invention is not limited in its application to the details of the construction and the arrangement of the components set forth in the following description or illustrated in the drawings. The invention is capable of other embodiments and of being practiced or of being carried out in various ways. Also, it is understood that the phraseology and terminology used herein is for the purpose of description and should not be regarded as limiting.

### DETAILED DESCRIPTION

Many different types of information and/or communication systems exist that require connectivity to each other and to peripheral devices used with the information and/or communication systems. Information and/or communication systems may include, for example, data networks, audio and/or video systems, etc. Connectivity to information and/or communication systems may occur in a wide variety of locations and such connectivity may be comprised of a wide variety of different types of modules. Exemplary locations for connectivity include, but are not limited to, walls, raceways, or any other locations where connectivity is required.

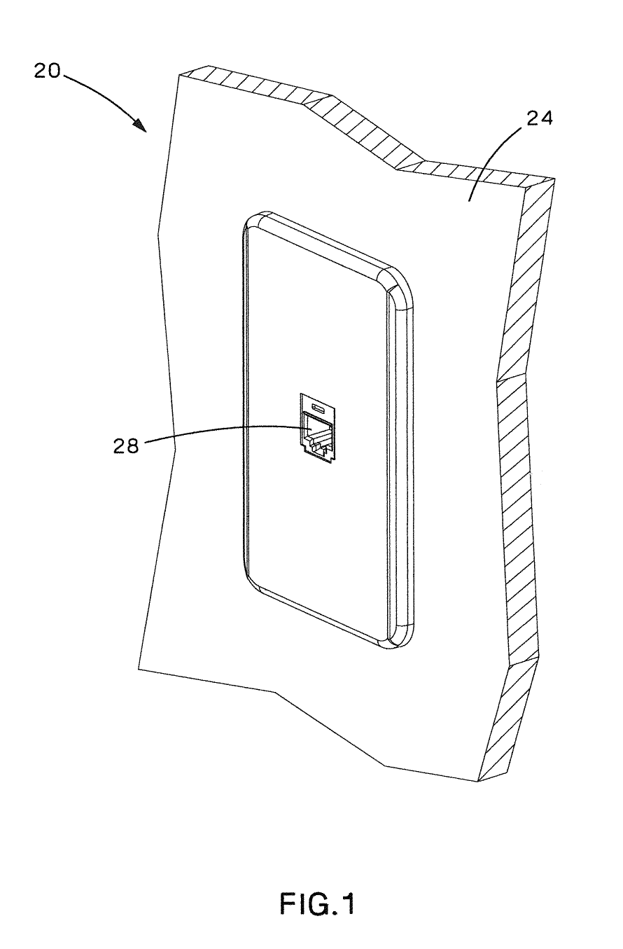

With reference to FIG. 1, an exemplary faceplate assembly 20 is illustrated and is coupled to a surface 24 such as, for example, a wall. The faceplate assembly 20 facilitates mounting of connectivity to the surface 24. The faceplate assembly 20 is adapted to accommodate a variety of different jack 28 densities such as, for example, one jack, two jacks, three jacks, four jacks, and six jacks.

In some environments, numerous faceplate assemblies 20 may be required and may be coupled to the same surface 24. The faceplate assemblies 20 may be positioned adjacent to each other and each faceplate assembly 20 may include a different number of jacks 28. The faceplate assembly 20 of the present invention is capable of centering the jack(s) 28 within the faceplate assembly 20 while providing the ability to align top edges of adjacent faceplate assemblies 20 in a substantially collinear manner with each other and also align bottom edges of adjacent faceplate assemblies 20 in a substantially collinear manner with each other.

Referring to FIGS. 1-5, the faceplate assembly 20 includes a backing member 32, a plurality of fasteners 36, a label 40, a label cover 44, and a cover 48. The backing member 32 and the cover 48 may each be constructed as a single unitarily formed piece of plastic. Additionally, the backing member 32 and the cover 48 may be injection molded. A standard electrical box 52 includes two flanges 56 with each flange 56 including an aperture 60 therein. The fasteners 36 are inserted in the apertures 60 to couple the backing member 32 to the flanges 56 of the electrical box 52.

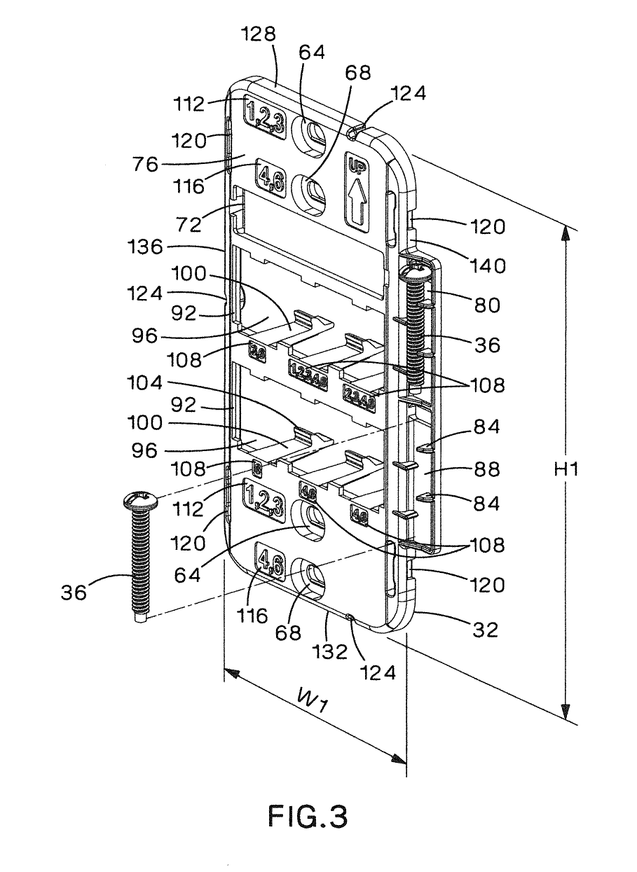

With particular reference to FIG. 3, the backing member 32 includes a first pair of mounting holes 64 and a second pair of mounting holes 68 defined through the backing member 32. The desired pair of mounting holes 64, 68 are aligned with the electrical box apertures 60 and the fasteners 36 may be inserted through the aligned pair of mounting holes 64, 68 and apertures 60 to couple the backing member 32 to the electrical box 52. All of the mounting holes 64, 68 are sufficiently recessed to inhibit the fasteners 36 from projecting significantly outward from a front of the backing member 32. Selection of a desired pair of mounting holes 64, 68 will be described in more detail below.

With continued reference to FIG. 3, the backing member 32 also includes a label receptacle 72 defined therein for first receiving the label 40, then subsequently receiving the label cover 44 in the label receptacle 72 to capture the label 40 between the label cover 44 and the backing member 32. The label receptacle 72 is sufficiently deep to inhibit the label 40 and label cover 44 from significantly extending beyond a front surface 76 of the backing member 32. Any desired information may be produced on the label 40 to provide users with information relevant to the faceplate assembly 20.

The backing member 32 further includes a pair of fastener receptacles 80 for retaining the fasteners 36 when the fasteners 36 are not in use as in storage or shipping. Each fastener receptacle 80 includes a plurality of spaced-apart alternating offset projections 84 defining a cavity 88 therebetween in which the fastener 36 may be positioned and retained under friction.

The backing member 32 also defines a pair of jack apertures 92 therethrough. Each aperture 92 includes a plurality of ports 96 defined therein for receiving jacks 28. In the illustrated exemplary embodiment, each aperture 92 includes three ports 96, thereby providing the backing member 32 with a total of six ports 96. It should be understood that the backing member 32 may have any number of apertures (including one) and may include any number of ports 96 for receiving any number of jacks 28 or other modular components, such as HDMI coupler, HDMI to RJ45 converter, USB coupler, RCA, F type, BNC, fiber-optic (SC, LC, ST., etc, and other types of modules.

Each port 96 includes a hook latch 100 for releasably securing a jack 28. The hook latch 100 includes an upward extending projection 104 to engage a jack 28. The hook latch 100 may also be resilient to facilitate movement of the hook latch 100 relative to the jack 28 and facilitate engagement and disengagement of the projection 104 with the jack 28.

The backing member 32 further includes port indicia 108 positioned on a front surface 76 of the backing member 32 under each of the ports 96. The port indicia 108 identifies in which ports 96 one or more jacks 28 should be positioned depending on the number of jacks 28 that will be supported by the faceplate assembly 20. For example, if only one jack 28 is supported by the faceplate assembly 20, the single jack 28 is positioned in the port 96 with a number “1” below it. In the illustrated exemplary embodiment, the port 96 including the number “1” below it is the top center port 96. If, for example, two jacks 28 are supported by the faceplate assembly 20, the jacks 28 are positioned in the two ports 96 with a number “2” below it. In the illustrated exemplary embodiment, the two ports 96 with the number “2” below them are the top center port 96 and the top right port 96. This procedure applies to one, two, three, four, and six jacks 28 supported by the faceplate assembly 20. It should be understood that the port indicia 108 may be located in other positions relative to the jack apertures 92 and ports 96. For example, the port indicia 108 may be positioned above the ports 96, in the ports 96, on the hook latches 100, beside the ports 96, or any other position. It should also be understood that the port indicia 108 may take foul's other than numeric. The port indicia 108 may have any form that indicates where to locate jacks 28 based on the number of jacks 28. For example, the port indicia 108 may be letters, symbols, etc.

The backing member 32 also includes mounting indicia 112, 116 positioned adjacent to the mounting holes 64, 68. The mounting indicia 112, 116 identifies the pair of mounting holes 64, 68 to use depending on the number of jacks 28 supported by the faceplate assembly 20. In the illustrated exemplary embodiment, the mounting indicia 112, 116 includes first mounting indicia 112 associated with the first pair of mounting holes 64 and second mounting indicia 116 associated with the second pair of mounting holes 68. The first mounting indicia 112 recites “1, 2, 3” and the second mounting indicia 116 recites “4, 6”. Thus, if one, two, or three jacks 28 are supported by the faceplate assembly 20, the fasteners 36 are inserted through the first pair of mounting holes 64 and secured to the electrical box 52, and if four or six jacks 28 are supported by the faceplate assembly 20, the fasteners 36 are inserted through the second pair of mounting holes 68 and secured to the electrical box 52. It should also be understood that the mounting indicia 112, 116 may take foul's other than numeric. The mounting indicia 112, 116 may have any form that indicates where to locate jacks 28 based on the number of jacks 28. For example, the mounting indicia 112, 116 may be letters, symbols, etc.

With particular reference to FIG. 3, the backing member 32 further includes a plurality of flexible latches 120 engageable by the cover 48 to secure the cover 48 to the backing member 32. In the illustrated exemplary embodiment, the backing member 32 includes four flexible latches 120, two latches 120 on a right edge 140 of the backing member 32 and two latches 120 on a left edge 136 of the backing member 32. It should be understood that the backing member 32 may include any number of latches 120 (including one) arranged in any configuration around the backing member 32.

With continued reference to FIG. 3, the backing member 32 also includes a plurality of slots 124 defined therein to assist with proper alignment of the cover 48 when connecting the cover 48 to the backing member 32. In the illustrated exemplary embodiment, the backing member 32 defines three slots 124 therein. A first slot 124 is defined in a top edge 128 of the backing member 32, a second slot 124 is defined in a bottom edge 132 of the backing member 32, and a third slot 124 is defined in a left edge 136 of the backing member 32. The first and second slots 124 are respectively defined in the top and bottom edges 128, 132 of the backing member 32 on a right half of the backing member 32 closer to a right edge 140 of the backing member 32 than the left edge 136. The third slot 124 is defined in the left edge 136 of the backing member 32 on a top half of the backing member 32 closer to the top edge 128 of the backing member 32 than the bottom edge 132.

In the illustrated exemplary embodiment, the backing member 32 includes a width W1 and a height H1.

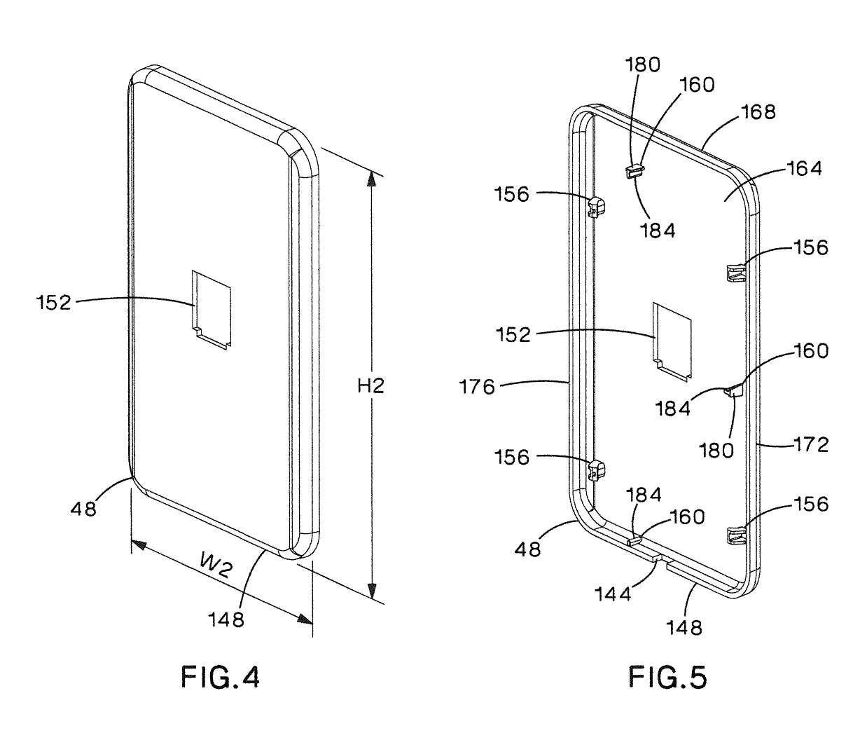

Referring now to FIGS. 4 and 5, an exemplary cover 48 of the faceplate assembly 20 is illustrated. As indicated above, the faceplate assembly 20 is adapted to support any number and any type of jacks 28 and, similarly, the cover 48 may be appropriately configured to accommodate any number and any type of jacks 28. The exemplary embodiment of the cover 48 illustrated in FIGS. 4 and 5 is adapted to support a single networking jack 28. The cover 48 includes a release slot 144 in a bottom edge 148 thereof to facilitate removal of the cover 48 from the backing member 32. A screwdriver or other device may be inserted into the release slot 144 and manipulated to remove the cover 48 from the backing member 32.

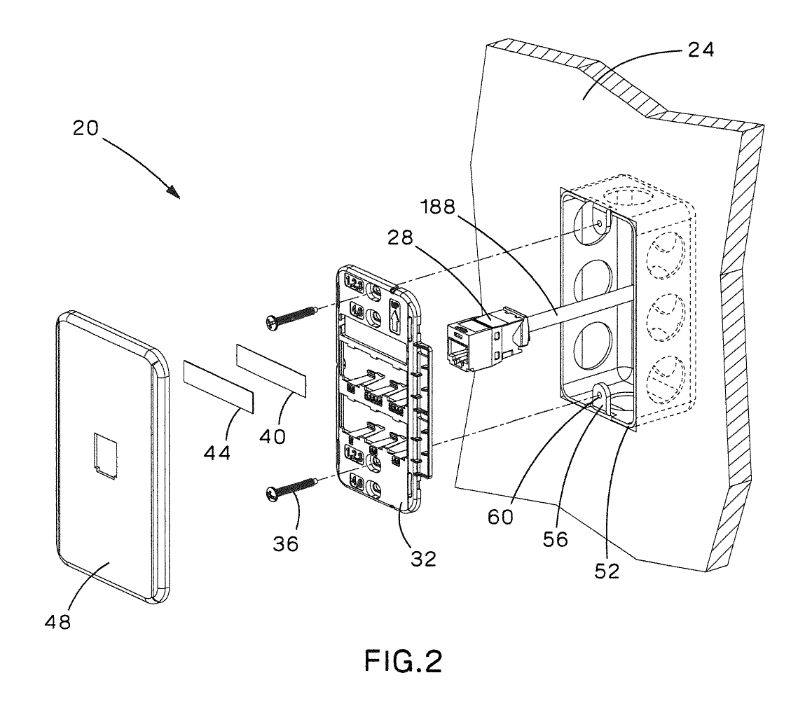

The cover 48 also includes an opening 152 defined therethrough sized and shaped to receive the single networking jack 28 (see FIGS. 1 and 2). The cover 48 further includes a plurality of rigid latches 156 engageable with the flexible latches 120 included on the backing member 32 to couple the cover 48 to the backing member 32. In the illustrated exemplary embodiment, the cover 48 includes four rigid latches 156 to engage the four flexible latches 120 on the backing member 32. The cover 48 may include any number of rigid latches 156 (including one) to couple the cover 48 to the backing member 32. In some exemplary embodiments, it may be preferable to include a complementary number of rigid latches 156 and flexible latches 120. The flexible latches 120 may be included on the cover 48, the rigid latches 156 on the backing member 32, or at least one rigid latch 156 on both the cover 48 and the backing member 32 and at least one flexible latch 120 on both the cover 48 and the backing member 32.

The cover 48 further includes a plurality of projections 160 to assist with proper alignment of the cover 48 when connecting the cover 48 to the backing member 32. In the illustrated exemplary embodiment, the cover 48 includes three projections 160. A first projection 160 is positioned on an interior surface 164 of the cover 48 near a top edge 168 of the cover 48, a second projection 160 is positioned on an interior surface of the bottom edge 148 of the cover 48, and a third projection 160 is positioned on the interior surface 164 of the cover 48 near a left edge 172 of the cover 48. The first and second projections 160 are respectively positioned on a right half of the cover 48 closer to the right edge 176 of the cover 48 than the left edge 172 of the cover 48. The third projection 160 is positioned on a top half of the cover 48 closer to the top edge 168 of the cover 48 than the bottom edge 148 of the cover 48.

The first and third projections 160 each include a base 180 and an engagement portion 184. The base 180 is wider than the engagement portion 184. The second projection 160 only includes an engagement portion 184 since the second projection 160 is positioned on the interior bottom edge 148 of the cover 48, which may be considered a wider base of the second projection 160. The engagement portions 184 of the projections 160 are complementarily shaped to the slots 124 defined in the backing member 32 such that the engagement portions 184 may slide into and out of the slots 124. The bases 180 of the first and third projections 160 and the interior bottom edge 148 of the cover 48 associated with the second projection 160 are much wider than the slots 124 to prohibit their insertion into the slots 124 and to define an insertion limit for the projections 160. In order for the cover 48 to properly couple to the backing member 32, all of the projections 160 must align with their respective slots 124 and the projections 160 must slide into their respective slots 124. The complementary projections 160 and slots 124 may be considered keying features to perform a keying operation. Coupling of the cover 48 to the backing member 32 will be described in more detail below.

In the illustrated exemplary embodiment, the cover 48 includes a width W2 and a height H2. The cover 48 may include any width and height as long as the width W2 of the cover 48 is greater than the width W1 of the backing member 32 and the height H2 of the cover 48 is greater than the height H1 of the backing member 32.

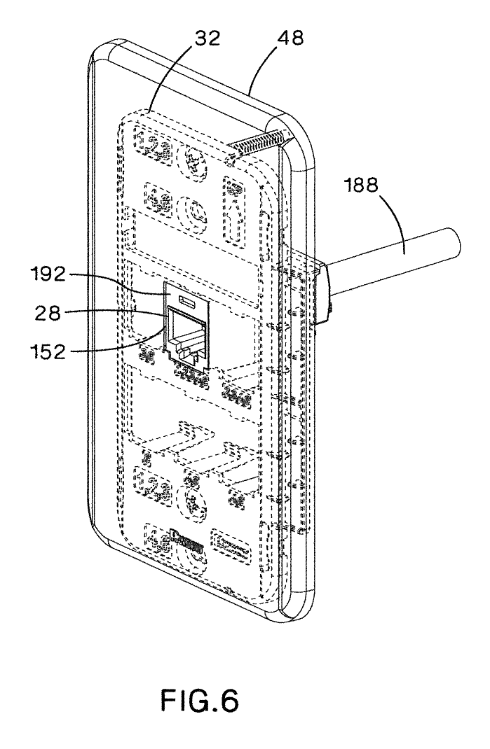

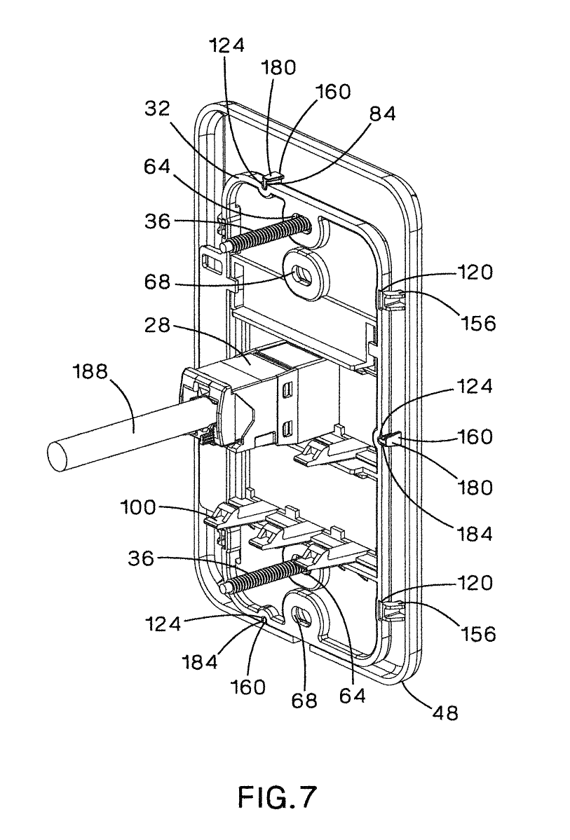

With reference to FIGS. 1-7, an electrical box 52 coupled to a surface 24 may provide a desirable location for supporting connectivity to information systems and the faceplate assembly 20 may be coupled to the electrical box 52 to support such connectivity. A desired number of jacks 28 and their associated cables 188 are routed to the electrical box 52. In the illustrated exemplary embodiment, a jack 28 is shown. The backing member 32 must be coupled to the electrical box 52 to accommodate the single jack 28. Since a single jack 28 will be supported by the faceplate assembly 20, the first pair of mounting holes 64 having the mounting indicia “1, 2, 3” adjacent thereto will be utilized to couple the backing member 32 to the electrical box 52. Fasteners 36 are inserted through the first pair of mounting holes 64 and threaded into the apertures 60 defined in the flanges 56 of the electrical box 52 to secure the backing member 32 to the electrical box 52. The single jack 28 is then coupled to the appropriate port 96 defined in the backing member 32. Since a single jack 28 will be supported by the faceplate assembly 20, the single jack 28 is positioned in the port 96 having the indicia “1, 2, 3, 4, 6” adjacent thereto. This is the only port including indicia having a “1” therein. The hook latch 100 associated with this port 96 engages the jack 28 and releasably secures the jack 28 to the backing member 32 (see also FIGS. 3 and 7).

With continued reference to FIGS. 1-7, the cover 48 may now be coupled to the backing member 32. The cover 48 includes an opening 152 therein configured to receive the jack 28 coupled to the backing member 32. A user aligns the opening 152 with the jack 28 and also aligns the projections 160 on the cover 48 with their respective slots 124 defined in the backing member 32. Once aligned, the user moves the cover 48 toward the surface 24, which causes the projections 160 to slide within their respective slots 124 and a front surface 192 of the jack 28 to insert into the opening 152 defined in the cover 48. The cover 48 continues to slide onto the backing member 32 until the rigid latches 156 on the cover 48 engage and couple to the flexible latches 120 on the backing member 32. The cover 48 is now coupled to the backing member 32. Once coupled, the jack 28 is substantially centered both horizontally and vertically in the cover 48 and a front surface 192 of the jack 28 is substantially flush with a front surface 196 of the cover 48, thereby providing an aesthetically pleasing faceplate assembly 20. Additionally, the cover 48 covers the backing member 32, the fasteners 36, the label 40, the label cover 44, and other components of the faceplate assembly 20 to provide an aesthetically pleasing faceplate assembly 20.

In the illustrated exemplary embodiment, the port 96 utilized for the jack 28 is substantially centered on a centerline of the backing member 32. The projections 160, slots 124, and rigid latches 156 on the cover 48 are positioned to centrally align the jack 28, and to position the front surface 192 of the jack 28 substantially flush with the front surface 196 of the cover 48.

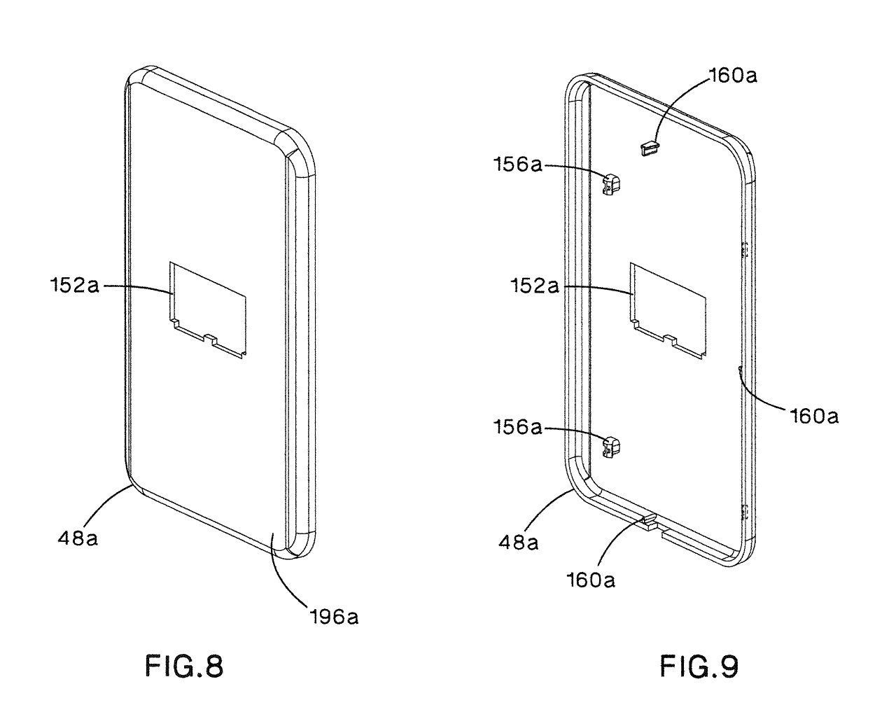

Referring now to FIGS. 8-11, another exemplary embodiment of a cover 48a of the faceplate assembly 20a is illustrated. Faceplate assembly 20a is identical to faceplate assembly 20 except for the cover 48a includes an opening 152a designed to reveal two jacks 28. As described above, the cover 48a is coupled to the backing member 32 illustrated in FIGS. 2 and 3.

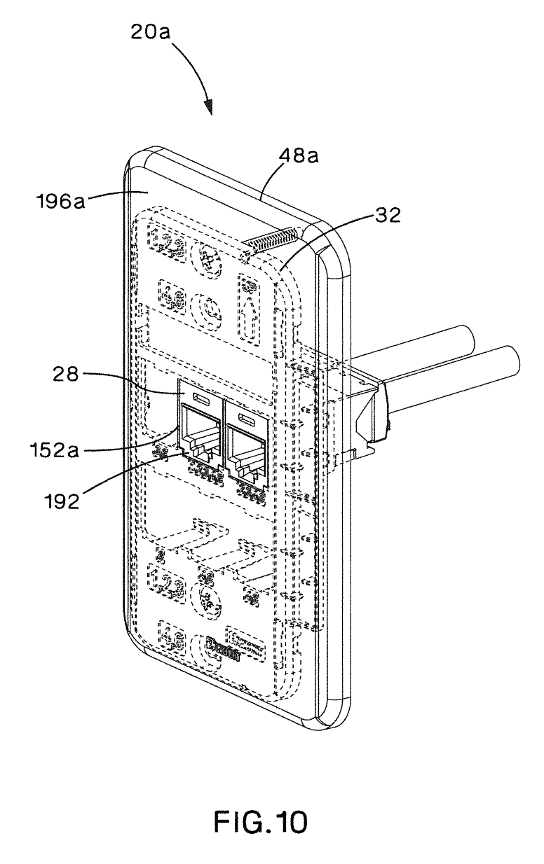

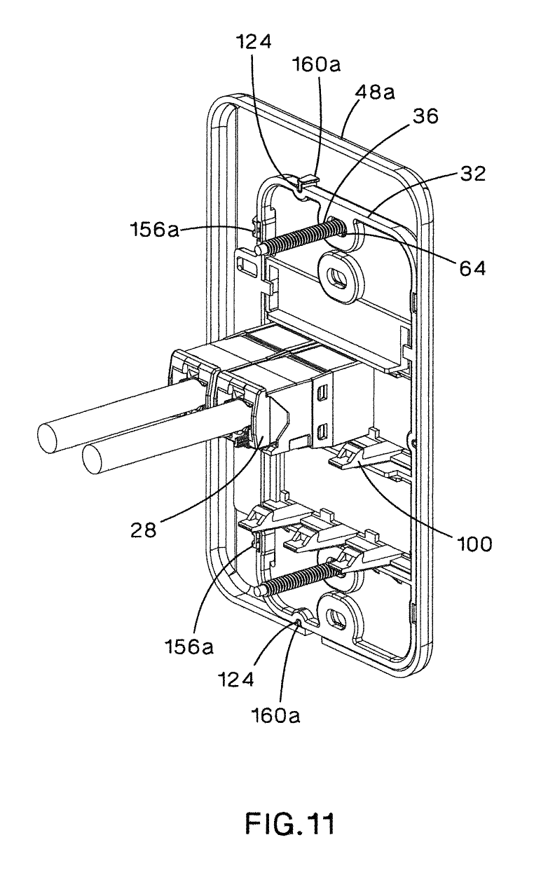

The backing member 32 must be coupled to the electrical box 52 to accommodate the two jacks 28. Since two networking jacks 28 will be supported by the faceplate assembly 20a, the first pair of mounting holes 64 having the mounting indicia “1, 2, 3” adjacent thereto will be utilized to couple the backing member 32 to the electrical box 52. Fasteners 36 are inserted through the first pair of mounting holes 64 and threaded into the apertures 60 defined in the flanges 56 of the electrical box 52 to secure the backing member 32 to the electrical box 52. The two jacks 28 are then coupled to the appropriate ports 96 defined in the backing member 32. Since two jacks 28 will be supported by the faceplate assembly 20a, a first 28 is positioned in the port 96 having the indicia “1, 2, 3, 4, 6” adjacent thereto and the second jack 28 is positioned in the port 96 having the indicia “2, 3, 4, 6”. The hook latches 100 associated with these two ports 96 engage their respective networking jacks 28 and releasably secure the networking jacks 28 to the backing member 32 (see also FIGS. 10 and 11).

The projections 160a and rigid latches 156a on the cover 48a and the slots 124 on the backing plate 32 are positioned to centrally align the two networking jacks 28 vertically and horizontally, and to position the front surfaces 192 of the networking jacks 28 substantially flush with the front surface 196a of the cover 48a.

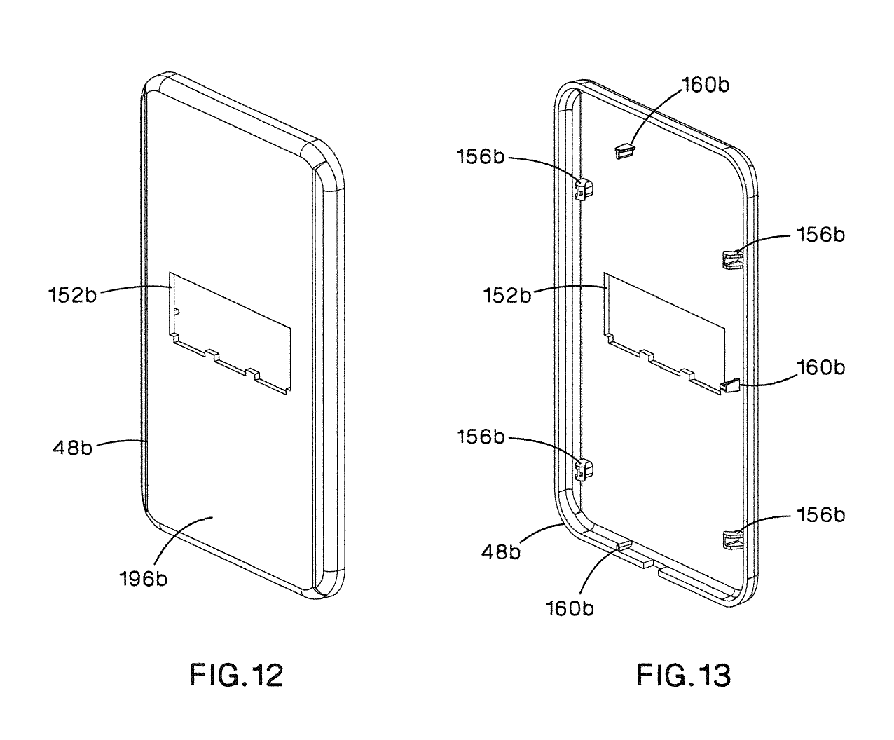

Referring now to FIGS. 12-15, another exemplary embodiment of a cover 48b of the faceplate assembly 20b is illustrated. The cover 48b illustrated in FIGS. 12 and 13 is adapted to support three jacks 28. The cover 48b may be coupled to the same backing member 32 illustrated in FIGS. 2 and 3. The cover 48b includes an opening 152b designed to reveal three jacks 28.

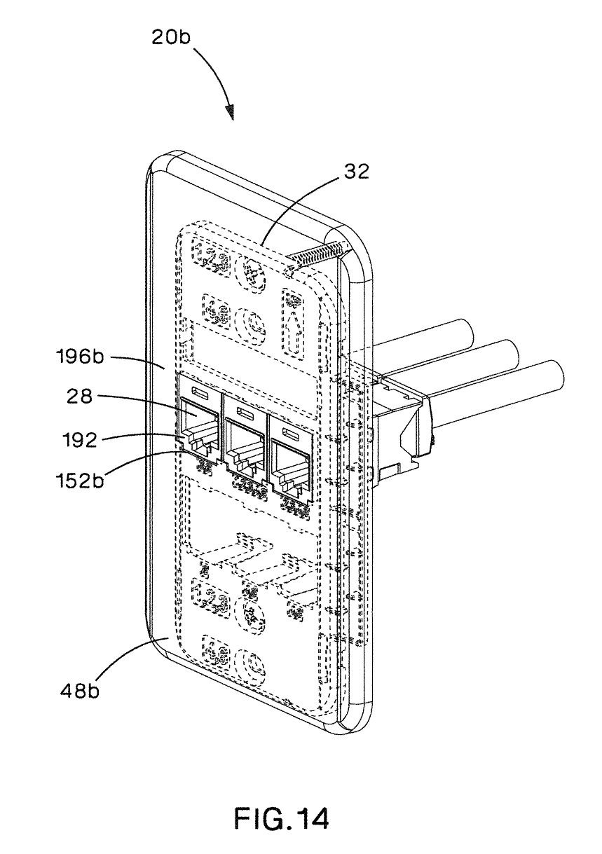

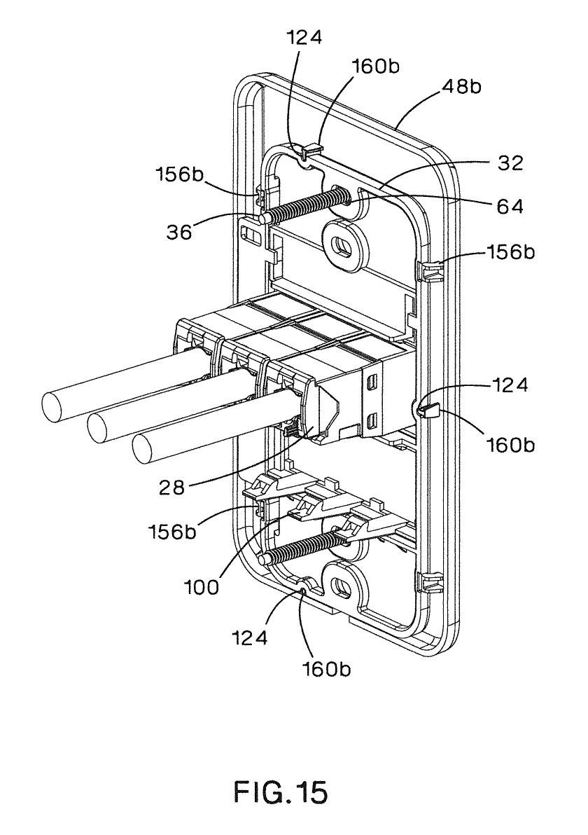

The backing member 32 must be coupled to the electrical box 52 to accommodate the three jacks 28. Since three jacks 28 will be supported by the faceplate assembly 20b, the first pair of mounting holes 64 having the mounting indicia “1, 2, 3” adjacent thereto will be utilized to couple the backing member 32 to the electrical box 52. Fasteners 36 are inserted through the first pair of mounting holes 64 and threaded into the apertures 60 defined in the flanges 56 of the electrical box 52 to secure the backing member 32 to the electrical box 52. The three jacks 28 are then coupled to the appropriate ports 96 defined in the backing member 32. Since three jacks 28 will be supported by the faceplate assembly 20b, a first jack 28 is positioned in the port 96 having the indicia “1, 2, 3, 4, 6” adjacent thereto, the second jack 28 is positioned in the port 96 having the indicia “2, 3, 4, 6”, and the third jack 28 is positioned in the port 96 having the indicia “3, 6”. The hook latches 100 associated with these three ports 96 engage their respective jacks 28 and releasably secure the jacks 28 to the backing member 32 (see FIGS. 14 and 15).

The projections 160b and rigid latches 156b on the cover 48b and the slots 124 on the backing plate 32 are positioned to centrally align the group of three networking jacks 28 vertically and horizontally, and to position the front surfaces 192 of the networking jacks 28 substantially flush with the front surface 196b of the cover 48b.

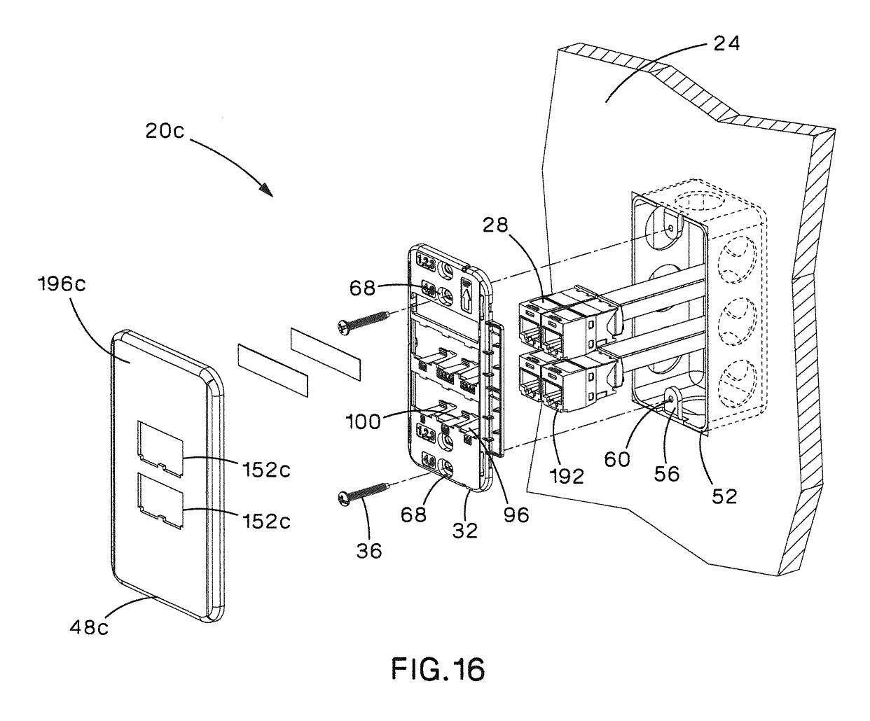

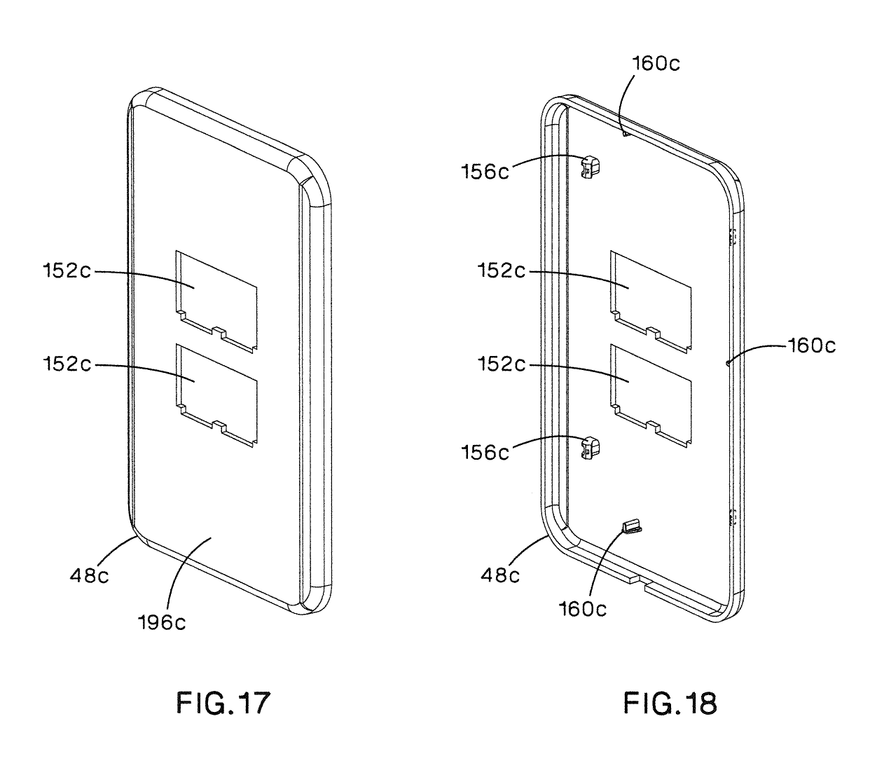

Referring now to FIGS. 16-18, another exemplary embodiment of a cover 48c of the faceplate assembly 20c is illustrated. The exemplary embodiment of the cover 48c illustrated in FIGS. 16-18 is adapted to support four jacks 28. The cover 48c includes two openings 152c designed to reveal four jacks 28. The cover 48c may be coupled to the same backing member 32 illustrated in FIGS. 2 and 3.

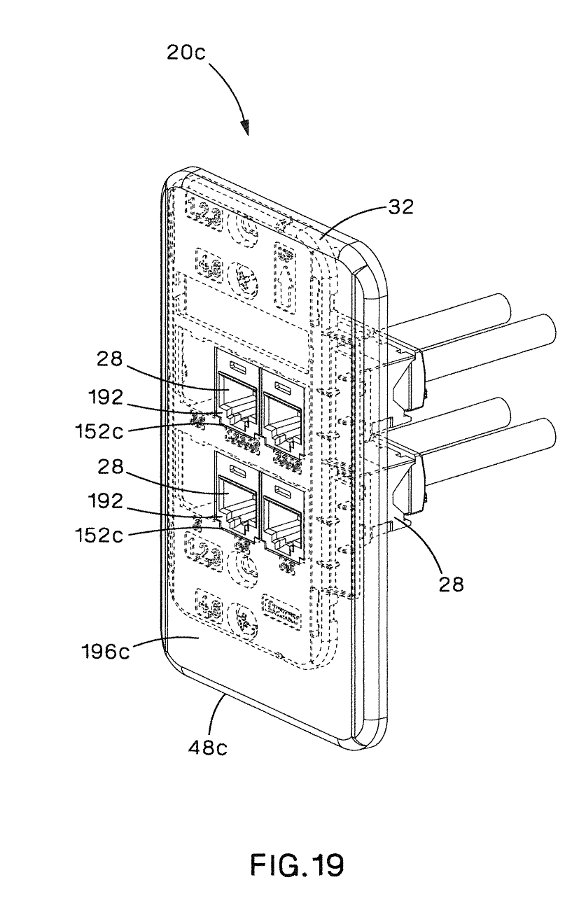

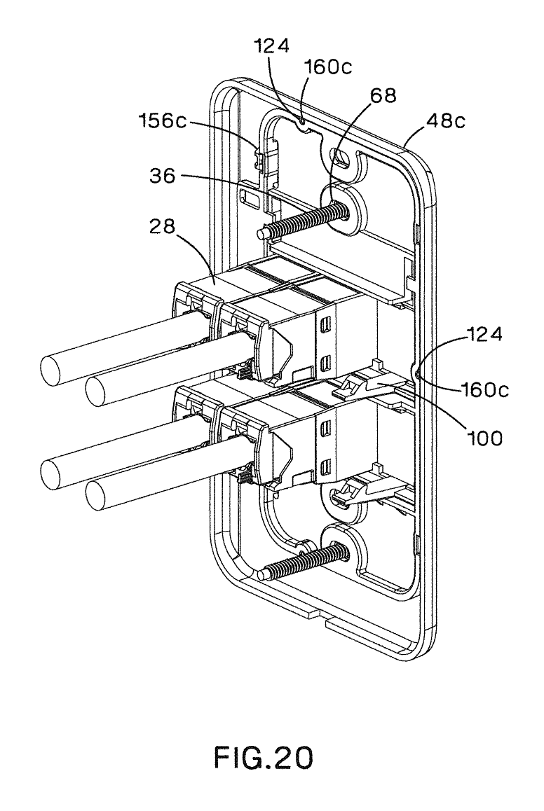

The backing member 32 must be coupled to the electrical box 52 to accommodate the four jacks 28. Since four jacks 28 will be supported by the faceplate assembly 20, the second pair of mounting holes 68 having the mounting indicia “4, 6” adjacent thereto will be utilized to couple the backing member 32 to the electrical box 52. Fasteners 36 are inserted through the second pair of mounting holes 68 and threaded into the apertures 60 defined in the flanges 56 of the electrical box 52 to secure the backing member 32 to the electrical box 52. The four jacks 28 are then coupled to the appropriate ports 96 defined in the backing member 32. Since four jacks 28 will be supported by the faceplate assembly 20c, a first jack 28 is positioned in the port 96 having the indicia “1, 2, 3, 4, 6” adjacent thereto, the second jack 28 is positioned in the port 96 having the indicia “2, 3, 4, 6”, the third jack 28 is positioned in the bottom middle port 96 having the indicia “4, 6”, and the fourth jack 28 is positioned in the bottom right port 96 having the indicia “4, 6.” The hook latches 100 associated with these four ports 96 engage their respective jack 28 and releasably secure the jacks 28 to the backing member 32 (see FIGS. 19 and 20).

The projections 160c and rigid latches 156c on the cover 48c and the slots 124 on the backing member 32 are positioned to centrally align the group of four networking jacks 28 vertically and horizontally, and to position the front surfaces 192 of the networking jacks 28 substantially flush with the front surface 196c of the cover 48c.

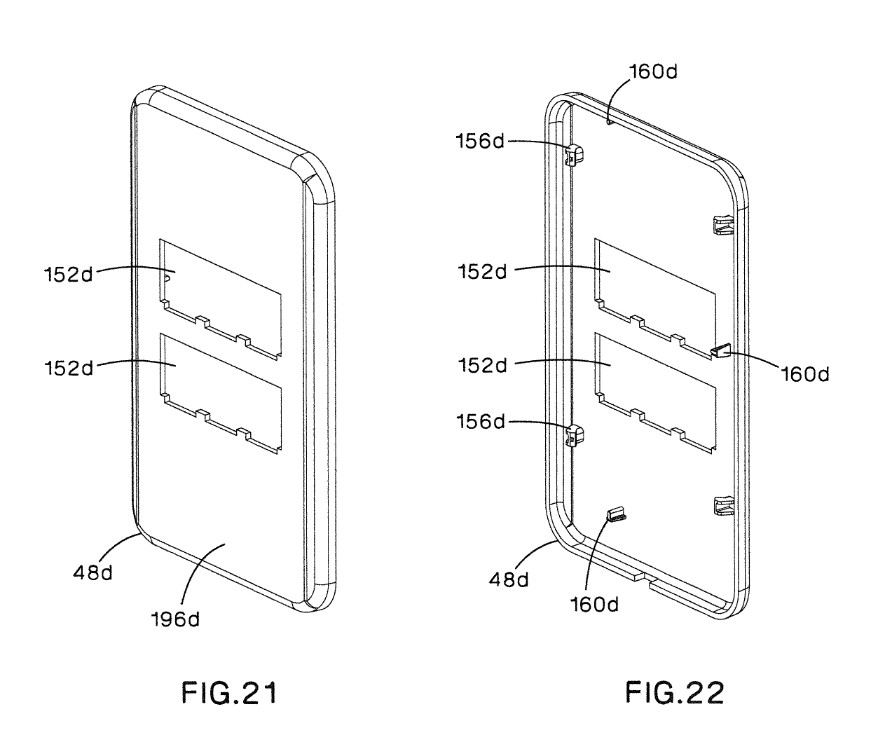

Referring now to FIGS. 21-24, another exemplary embodiment of a cover 48d of the faceplate assembly 20d is illustrated. The exemplary embodiment of the cover 48d illustrated in FIGS. 21 and 22 is adapted to support six jacks 28. The cover 48d may be coupled to the same backing member 32 illustrated in FIGS. 2 and 3. The cover 48d includes two openings 152d defined therethrough with each opening 152d designed to reveal three jacks 28.

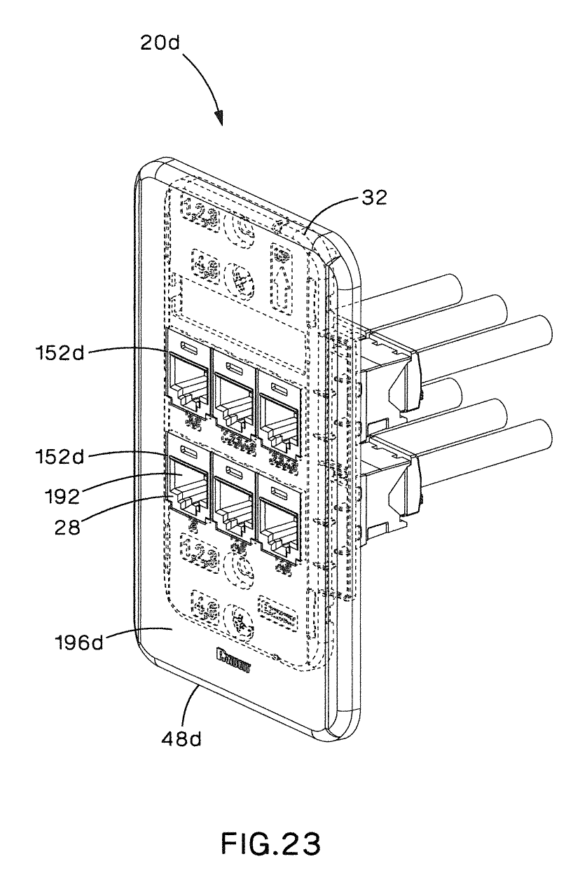

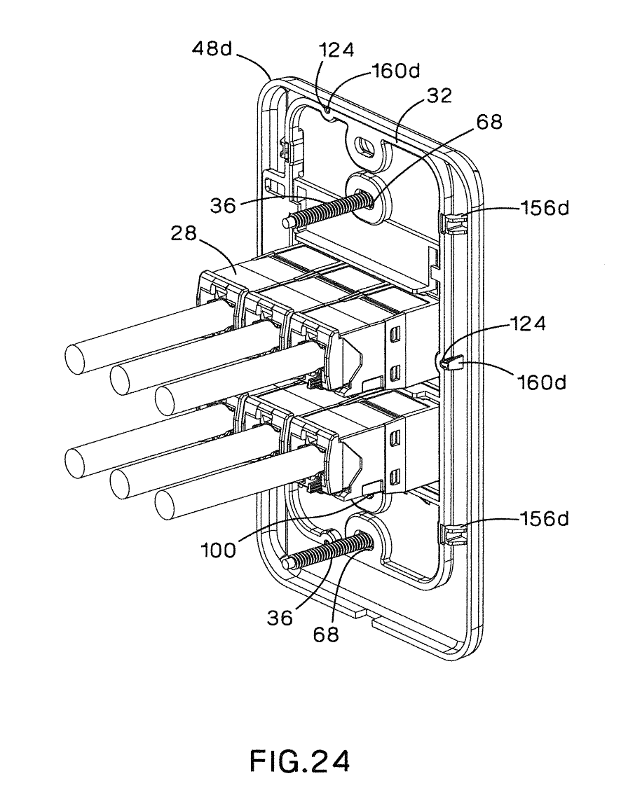

The backing member 32 must be coupled to the electrical box 52 to accommodate the six jacks 28. Since the faceplate assembly 20 supports six jacks 28, the second pair of mounting holes 68 having the mounting indicia “4, 6” adjacent thereto will be utilized to couple the backing member 32 to the electrical box 52. Fasteners 36 are inserted through the second pair of coupling apertures 68 and threaded into the apertures 60 defined in the flanges 56 of the electrical box 52 to secure the backing member 32 to the electrical box 52. The six jacks 28 are then coupled to the appropriate ports 96 defined in the backing member 32. Since six jacks 28 will be supported by the faceplate assembly 20 and the illustrated exemplary embodiment of the backing member 32 includes six ports 96, all six ports 96 will have a jack 28 positioned therein. The hook latches 100 associated with these six ports 96 engage their respective jack 28 and releasably secure the jacks 28 to the backing member 32 (see FIGS. 23 and 24).

The projections 160d and rigid latches 156d on the cover 48d and the slots 124 on the backing member 32 are positioned to centrally align the six networking jacks 28 vertically and horizontally, and to position the front surfaces 192 of the networking jacks 28 substantially flush with the front surface 196d of the cover 48d.

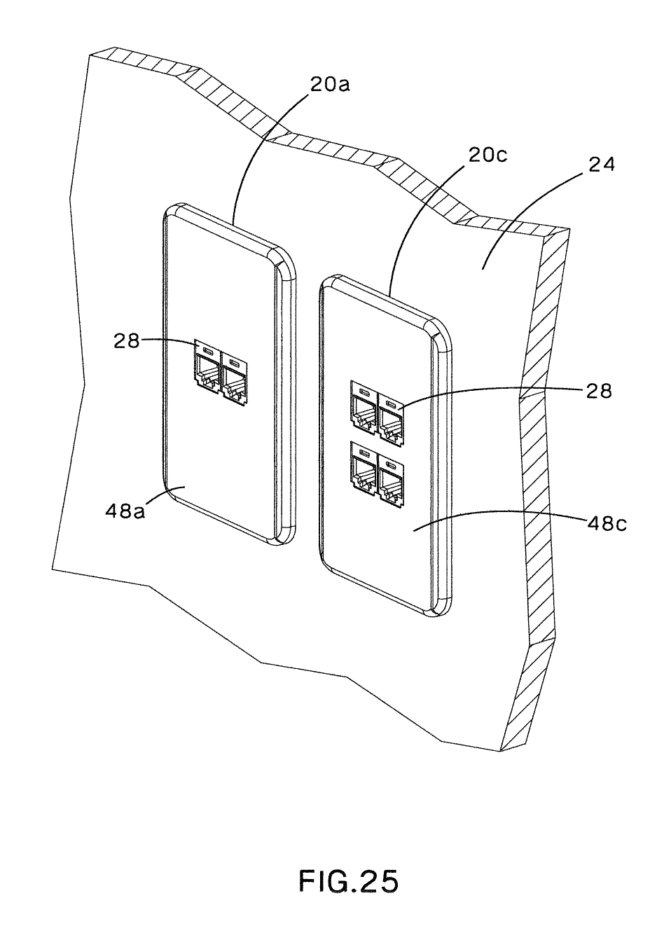

Referring now to FIG. 25, numerous faceplate assemblies 20a, 20c may be coupled to a surface 24 and the faceplate assemblies 20a, 20c are adapted to co-linearly align top edges of adjacent faceplate assemblies 20a, 20c and co-linearly align bottom edges of adjacent faceplate assemblies 20a, 20c. In the illustrated exemplary embodiment, a first faceplate assembly 20a supports two jacks 28 and a second faceplate assembly 20c supports four jacks 28.

The top and bottom edges of the covers 48a, 48c are collinear because of the ability for the backing plate 32 to offset due to the two sets of mounting holes 64, 68. An end user can positioned two or more faceplates, regardless of the port densities, next to each other and the top and bottom edges of the faceplates will be collinear. Also the jacks stay centered, horizontally and vertically, with respect to the cover because of the projections and the rigid latches resulting in an aesthetically appealing faceplate assembly.

A variety of faceplate assembly kits are also provided. In some exemplary embodiments, a faceplate assembly kit may include a backing member 232, a plurality of fasteners 236, a label 240, a label cover 244, and a single cover 248 for accommodating a configuration of connectivity module(s).

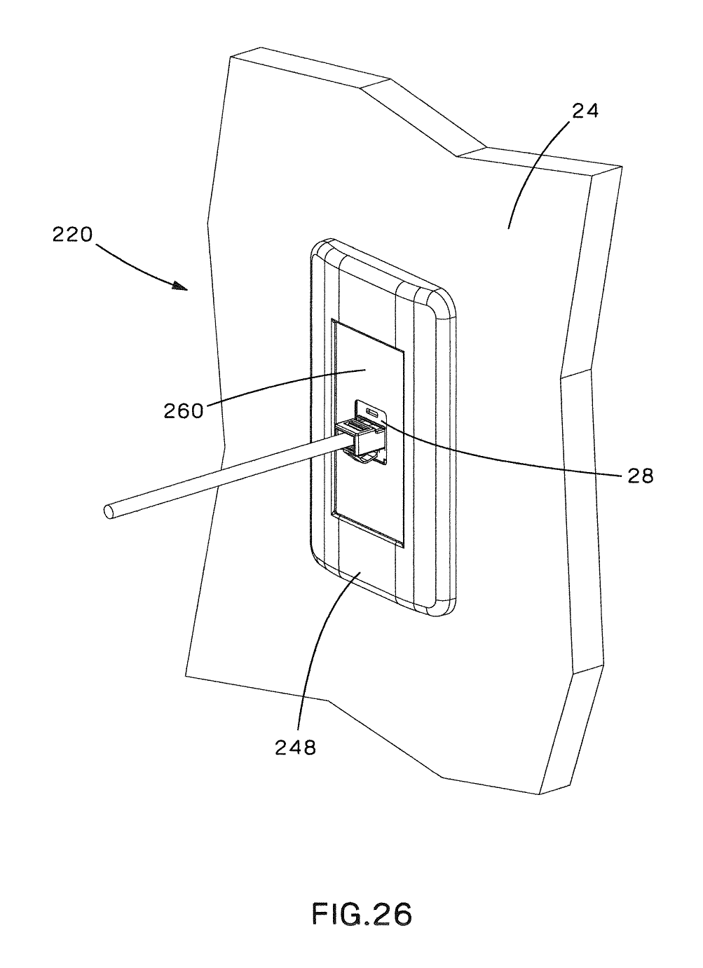

Referring now to FIG. 26, faceplate assembly 220 is illustrated and may be coupled to a surface 24 such as, for example, a wall. The faceplate assembly 220 facilitates mounting of connectivity to the surface 24. The faceplate assembly 220 is adapted to accommodate a variety of different jack 28 densities such as, for example, one jack, two jacks 28, three jacks, four jacks, five jacks, and six jacks.

In some environments, flexibility in faceplate assembly 220 structure and functionality is important. Connectivity designs may change and the faceplate assembly 220 is adapted to accommodate such connectivity design changes as they occur. For example, the number of jacks 28 to be supported by the faceplate assembly 220 may change over time and the faceplate assembly 220 is adapted to accommodate such changes. Additionally, connectivity designs are multiple and varied and installers want the ability to purchase a single faceplate assembly 220 that can accommodate a variety of different connectivity designs. The faceplate assembly 220 is also adapted to be coupled to the surface 24 in either a vertical orientation or a horizontal orientation. The faceplate assembly 220 of the present invention is adapted to provide all the above characteristics while also centering the jack(s) 28 within the faceplate assembly 220.

Referring now to FIGS. 26-28, the faceplate assembly 220 includes a backing member 232, a plurality of fasteners 236, two labels 240, two label covers 244, a module insert 256, a decorative member 260, and a cover 248. The backing member 232, the decorative member 260, and the cover 248 may each be constructed as a single unitarily formed piece of plastic. Additionally, the backing member 232, the decorative member 260, and the cover 248 may be injection molded. The backing member 232 may be coupled an electrical box (not shown) installed in the surface 24. As discussed above, a standard electrical box 52 includes two flanges 56 with each flange 56 including an aperture 60 therein. The fasteners 236 are used to couple the backing member 232 to the flanges 56 of the electrical box 52.

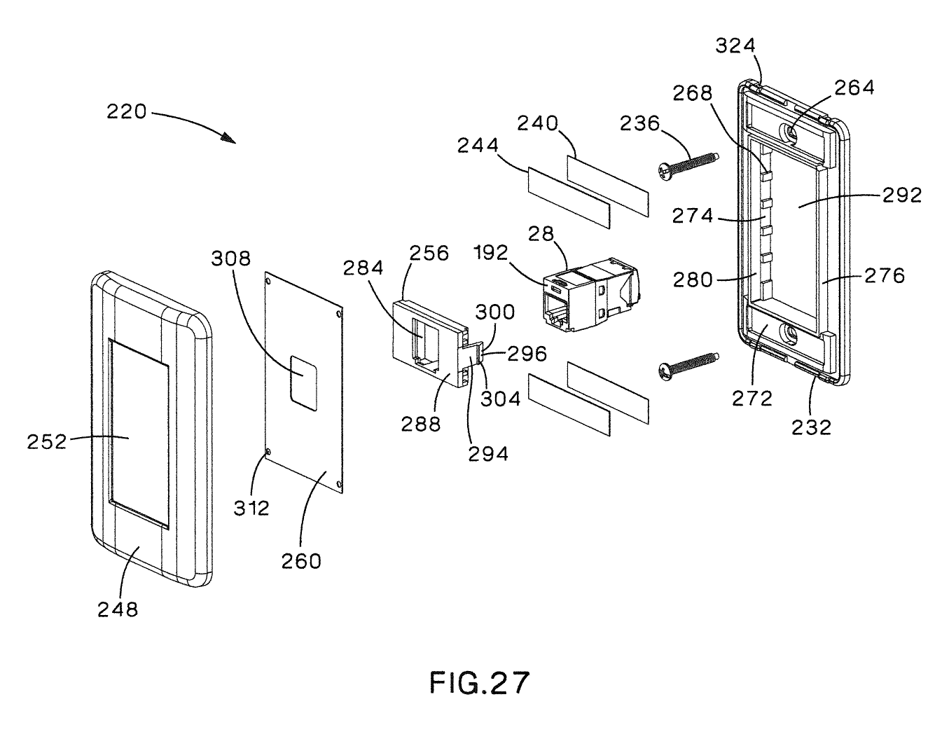

With particular reference to FIG. 27, the backing member 232 includes a pair of mounting holes 264 that may be aligned with apertures 60 in an electrical box 52 and through which the fasteners 236 may be inserted to couple the backing member 232 to the electrical box 52. In the illustrated exemplary embodiment, the mounting holes 264 are recessed to inhibit the fasteners 236 from projecting out of the mounting holes 264 when coupled to the electrical box 52. The backing member 232 also includes a pair of label receptacles 272 defined therein for receiving labels 240. In the illustrated exemplary embodiment, the mounting holes 264 are defined through the label receptacles 272 such that the fasteners 236 are covered by the labels 240 when the labels 240 are positioned in the label receptacles 272. Label covers 244 may be introduced into the label receptacles 272 subsequent to introduction of the labels 240 into the label receptacles 272 to cover and protect the labels 240 and capture the labels 240 between the label covers 244 and bottoms of the label receptacles 272 to secure the labels 240 in place. The label covers 244 are manufactured of a transparent or translucent material to enable an individual to see through the label covers 244 and read any indicia located on the labels 240. The label receptacles 272 are sufficiently deep to inhibit the labels 240 and label covers 244 from projecting outward of the label receptacles 272.

With particular reference to FIG. 27, the backing member 232 defines a jack aperture 292 therethrough for receiving one or more inserts 256 therein. The jack aperture 292 is rectangular in shape and includes a plurality of projections 268 and recesses 274 defined in both right and left edges 276, 280 of the jack aperture 292. In the illustrated exemplary embodiment, each side of the jack aperture 292 includes five recesses 274 defined between the projections 268. Alternatively, each edge 276, 280 of the jack aperture 292 may include any number of projections and any number of recesses.

With further reference to FIG. 27, the module insert 256 is generally rectangular in shape and defines a module opening 284 therein for receiving the jack 28. In the illustrated embodiment, the module opening 284 includes a single port for receiving the single jack 28. Alternatively, faceplate assembly 220 may support other types of connectivity modules having different shapes than the exemplary illustrated jack 28. Thus, the module opening 284 may have any shape to complement a shape of any type of connectivity module. When the jack 28 is coupled to the insert 256, a front surface 192 of the jack 28 is substantially flush with a front surface 288 of the insert 256. The insert 256 includes a hook latch 100 similar to those described above to couple the jack 28 to the insert 256. The insert 256 also includes a pair of connection members 294 with one connection member 294 positioned on a first side of the insert 256 and another of the connection members 294 positioned on a second side of the insert 256 opposite the first side. The connection members 294 may be resilient and each includes a projection 296 extending outward away from the insert 256. In the illustrated exemplary embodiment, each projection 296 includes a ramped surface 300 and a lip 304.

The insert 256 may be positioned in the jack aperture 292 in a variety of positions and coupled to the backing member 32 in those positions. As indicated above, the jack aperture 292 includes five recesses 274 in each of the right and left edges 276, 280 of the jack aperture 292. The connection members 294 of the insert 256 may be aligned with and inserted into any one of the five sets of recesses 274. The ramped surfaces 300 of the connection members 294 ride against the chosen set of the recesses 274, thereby deflecting the connection members 294 inward. As the ramped surfaces 300 pass by the set of recesses 274, the ramped surfaces 300 disengage the set of recesses 274 and the connection members 294 return outward to their non-deflected condition, thereby positioning the lips 304 of the connection members 294 behind the backing member 32. The insert 256 is then coupled to the backing member 32.

In the illustrated exemplary embodiment, the insert 256 is about one-third the size of the jack aperture 292 defined in the backing member 232. Thus, a total of three inserts 256 may be inserted into the jack aperture 292 and coupled to the backing member 232. It should be understood that the insert 256 may have any configuration and any size to accommodate a desired connectivity module design.

A desirable aspect of the faceplate assembly 220 is to provide an aesthetically pleasing faceplate assembly 220 that horizontally and vertically centers the connectivity module(s). In the exemplary embodiment illustrated in FIGS. 26-28, the jack 28 will be centered vertically and horizontally when the insert 256 is positioned in a center set of recesses 274 (also identified as the third set of recesses when initiating counting from either the bottom or the top set of recesses). The insert 256 may be coupled to the backing member 232 in any of the set of recesses 274, but coupling the insert 256 to the backing member 232 in the center set of recesses 274 will vertically and horizontally center the jack 28.

With continued reference to FIG. 27, the decorative member 260 defines a module opening 308 therein that is adapted to align with the module opening 284 in the insert 256 and the front surface 192 of the jack 28. In the illustrated exemplary embodiment, the module opening 308 in the decorative member 260 is sized and shaped to accommodate the single jack 28. Since the faceplate assembly 220 is adapted to support any number of jacks, the module opening 308 defined in the decorative member 260 may have any size and shape to complement the number and type of jacks 28 supported by the faceplate assembly 220. As indicated above, the insert 256 may be coupled to the backing member 32 in a variety of positions to locate the single jack 28 in a variety of positions. Accordingly, the module opening 308 defined in the decorative member 260 may be defined in the decorative member 260 in a variety of position to align with the position of the single jack 28. However, as also indicated above, a desirable aspect of the faceplate assembly 220 is to provide an aesthetically pleasing faceplate assembly 20 that horizontally and vertically centers the connectivity module(s). Thus, with the jack 28 centrally located as shown in the illustrated exemplary embodiment, the module opening 308 in the decorative member 260 is also vertically and horizontally centrally located to align with the centrally located jack 28. The decorative member 260 also includes a plurality of apertures 312 defined therein near the four corners of the decorative member 260.

The decorative member 260 is adapted to provide a wide variety of aesthetically pleasing and desired design options for users of the faceplate assembly 20. The decorative member 260 may be manufactured from a wide variety of materials, and may have a wide variety of textures, finishes, patterns, colors, etc. Exemplary materials and finishes may include, but are not limited to, glossy plastic, textured plastic, etched metal, smooth metal, polished metal, etc.

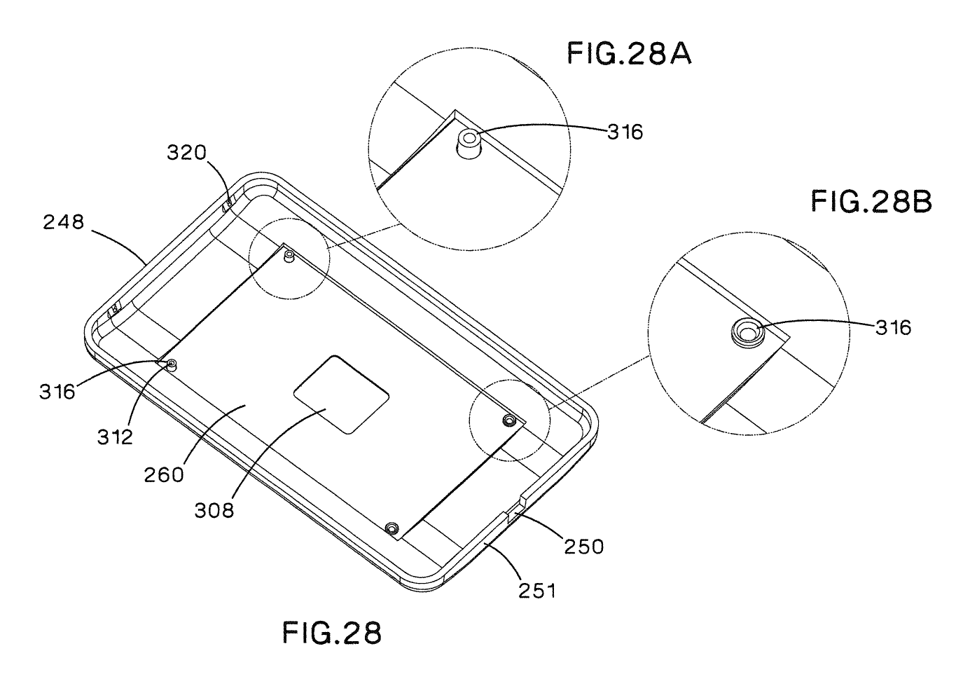

The cover 248 defines a cover opening 252 therethrough and includes a plurality of projections 316 extending from an interior surface of the cover 48 (see FIGS. 28 and 28A). The plurality of projections 316 are adapted to insert into the complementarily positioned apertures 312 defined in the decorative member 260. When the projections 316 are positioned in the apertures 312 and the decorative member 260 is slid onto the cover 248, a process may be performed to deform the projections 316 resulting in the decorative member 260 being coupled to the cover 48. The deformed projections 316 inhibit the decorative member 260 from sliding off of the projections 316. This process may be referred to as “staking”. A projection 316 is shown prior to deformation in FIG. 28A and a projection 316 is shown after deformation or staking in FIG. 28B.

The cover 248 further includes a plurality of latches 320 for engaging complementarily positioned latches 324 on the backing member 232 to releasably couple the cover 248 to the backing member 232. The cover 248 and the backing member 232 each include four latches 320, 324, respectively. Alternatively, the cover 248 and the backing member 232 may include any number of latches. These exemplary illustrated latches may be similar to the rigid and flexible latches described above or they may be different types of latches. Since the cover 248 and the decorative member 260 are coupled to each other, both the decorative member 260 and the cover 248 are removed together to expose the backing member 232 and other components of the faceplate assembly 220. The cover 248 further includes a release slot 250 in a bottom edge 251 thereof to facilitate removal of the cover 248 from the backing member 232. A screwdriver or other device may be inserted into the release slot 250 and manipulated to remove the cover 248 from the backing member 232.

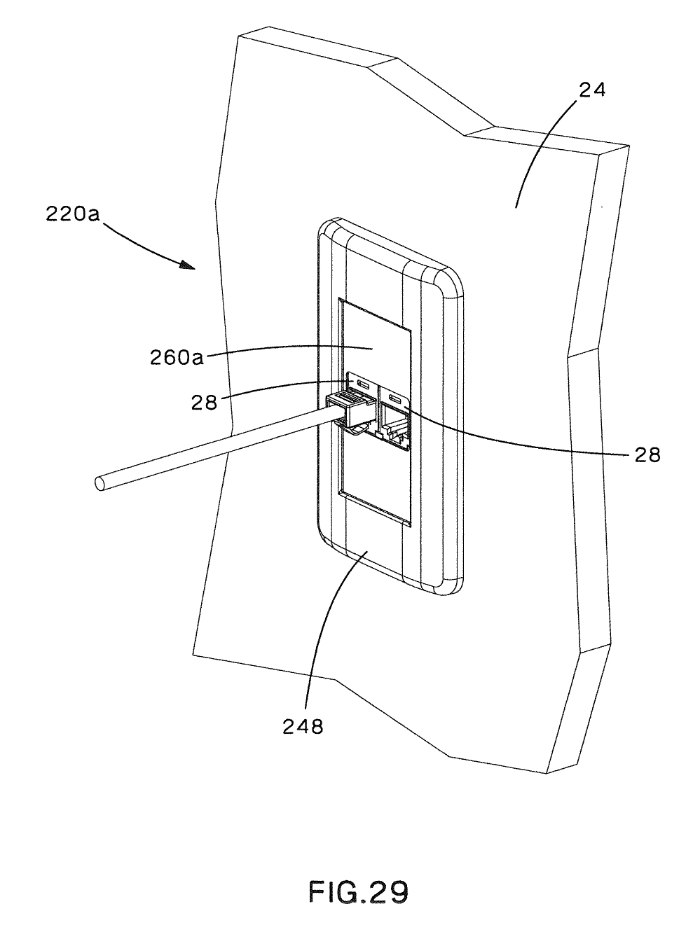

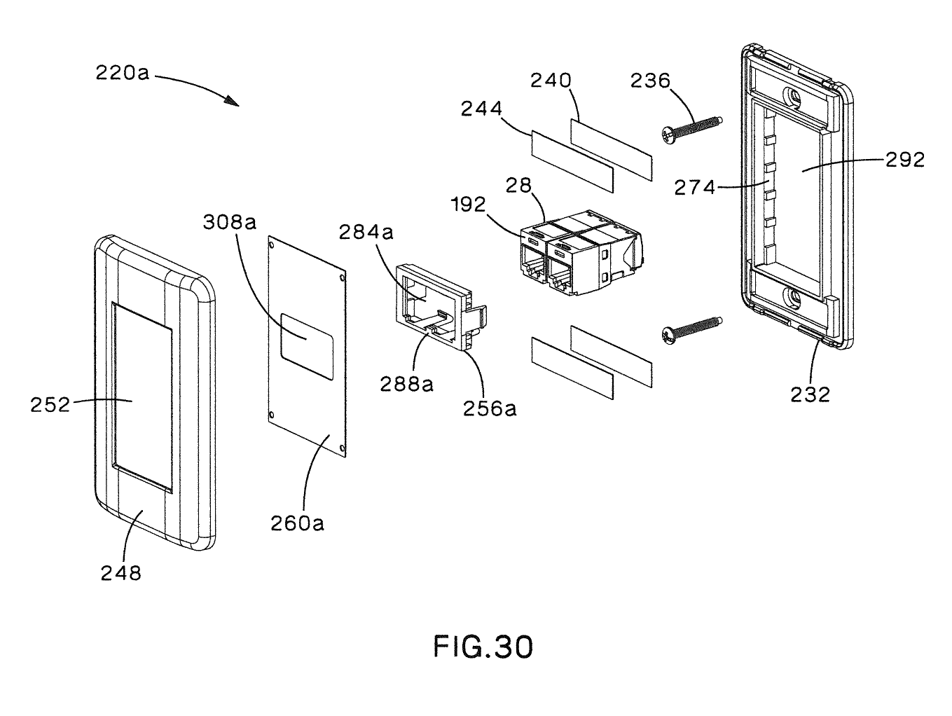

Referring to FIGS. 29 and 30, the faceplate assembly 220a is adapted to support two jacks 28 and includes another exemplary embodiment of a module insert 256a and another exemplary embodiment of a decorative member 260a. The faceplate assembly 220a includes backing member 232, fasteners 236, labels 240, label covers 244, and cover 248.

In the illustrated exemplary embodiment, the module insert 256a is generally rectangular in shape and defines a module opening 284a therein for receiving two jacks 28. When the jacks 28 are coupled to the insert 256a, front surfaces 192 of the networking jacks 28 are substantially flush with a front surface 288a of the insert 256a. The insert 256a may be coupled to the backing member 232 in a similar manner to the insert 256 described above in connection with FIGS. 26-28.

The insert 256a may be positioned in the connectivity aperture 292 in a variety of positions and coupled to the backing member 232 in any of those positions. The insert 256a is about one-third the size of the jack aperture 292 defined in the backing member 232.

As illustrated in FIGS. 29 and 30, the two jacks 28 will be centered vertically and horizontally when the insert 256a is positioned in a center set of recesses 274 (also identified as the third set of recesses when initiating counting from either the bottom or the top set of recesses). The insert 256a may be coupled to the backing member 232 in any of the set of recesses 274, but coupling the insert 256a to the backing member 232 in the center set of recesses 274 will vertically and horizontally center the jacks 28.

With continued reference to FIGS. 29 and 30, the decorative member 260a defines a module opening 308a therein that is adapted to align with the module opening 284a in the insert 256a and the front surfaces 192 of the two jacks 28. In the illustrated exemplary embodiment, the module opening 308a in the decorative member 260a is sized and shaped to accommodate the two jacks 28. As indicated above, the insert 256a may be coupled to the backing member 232 in a variety of positions to locate the two jacks 28 in a variety of positions. The module opening 308a in the decorative member 260a is also horizontally and vertically centered to align with the centrally located jacks 28. The decorative member 260a may be coupled to the cover 248 in all the same manners and may have all the same characteristics as the decorative member 260 described above in connection with FIGS. 26-28.

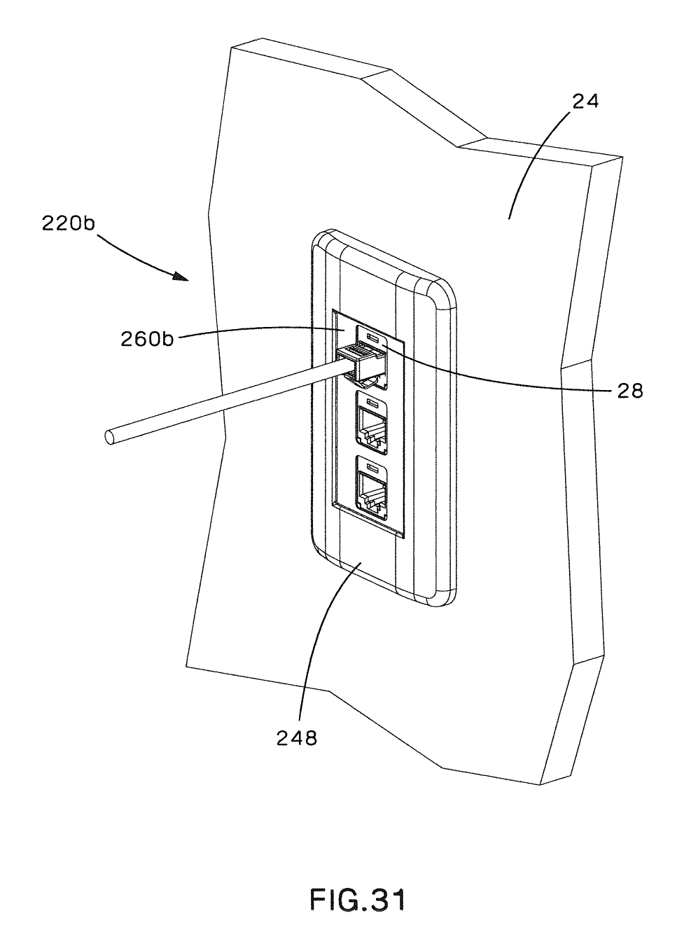

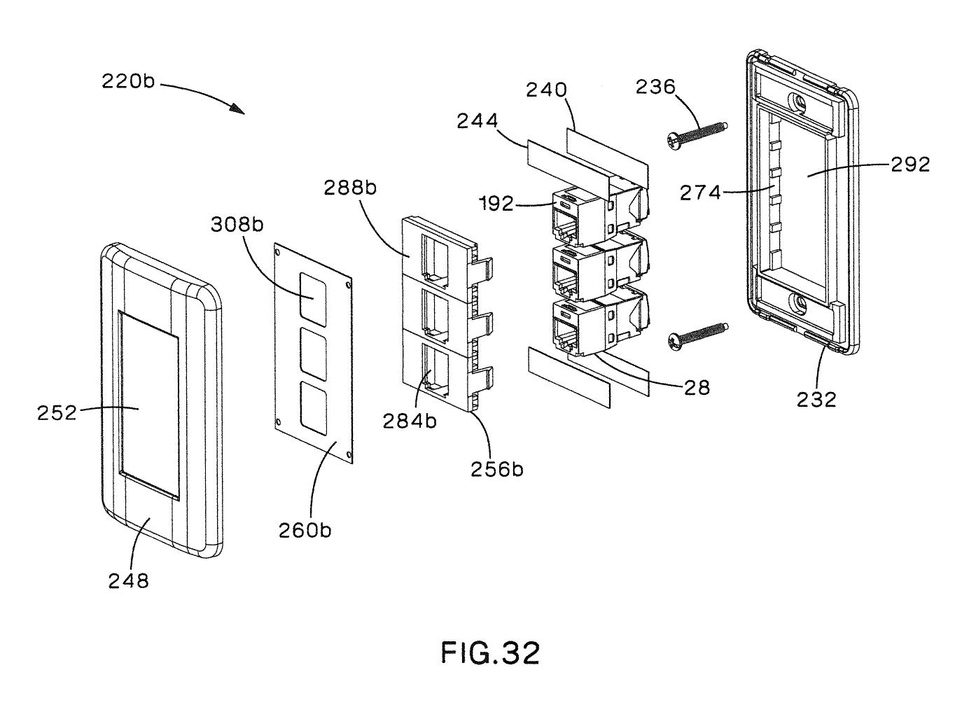

Referring now to FIGS. 31 and 32, the faceplate assembly 220b is adapted to support three jacks 28 and includes a plurality of module inserts 256b and another exemplary embodiment of a decorative member 260b. The faceplate assembly 220b includes backing member 232, fasteners 236, labels 240, label covers 244, and cover 248.

In the illustrated exemplary embodiment, the faceplate assembly 220b includes three substantially identical module inserts 256b all of which are similar to the module insert 256 described above in connection with FIGS. 26-28. Each module insert 256b includes a single port adapted to receive one jack 28 resulting in the faceplate assembly 220b supporting a total of three jacks 28. When the jacks 28 are coupled to the inserts 256b, front surfaces 192 of the jacks 28 are substantially flush with front surfaces 288b of the inserts 256b.

Each insert 256b is about one-third the size of the jack aperture 292 defined in the backing member 232.

As illustrated in FIGS. 31 and 32, the three jacks 28 will be centered vertically and horizontally within the faceplate assembly 220b when the inserts 256b are coupled to the backing member 232.

With continued reference to FIGS. 31 and 32, the decorative member 260b defines three module openings 308b therein that are adapted to align with the module openings 284b in the three inserts 256b and the front surfaces 192 of the three jacks 28. In the illustrated exemplary embodiment, the module openings 308b in the decorative member 260b are sized and shaped to accommodate the three jacks 28. As indicated above, a desirable aspect of the faceplate assembly 220b is to provide an aesthetically pleasing faceplate assembly 220b that horizontally and vertically centers the connectivity module(s). Thus, with the three jacks 28 centrally located as shown in the illustrated exemplary embodiment, the module openings 308b in the decorative member 260b are also centrally located to align with the centrally located jacks 28. The decorative member 260b may be coupled to the cover 248 in the same manner and may have all the same characteristics as the decorative member 260 described above in connection with FIGS. 26-28.

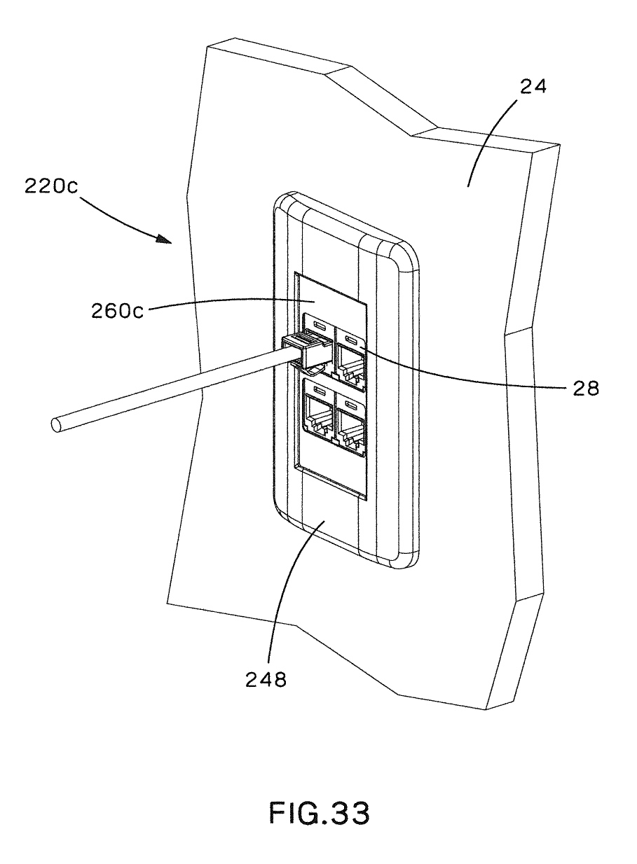

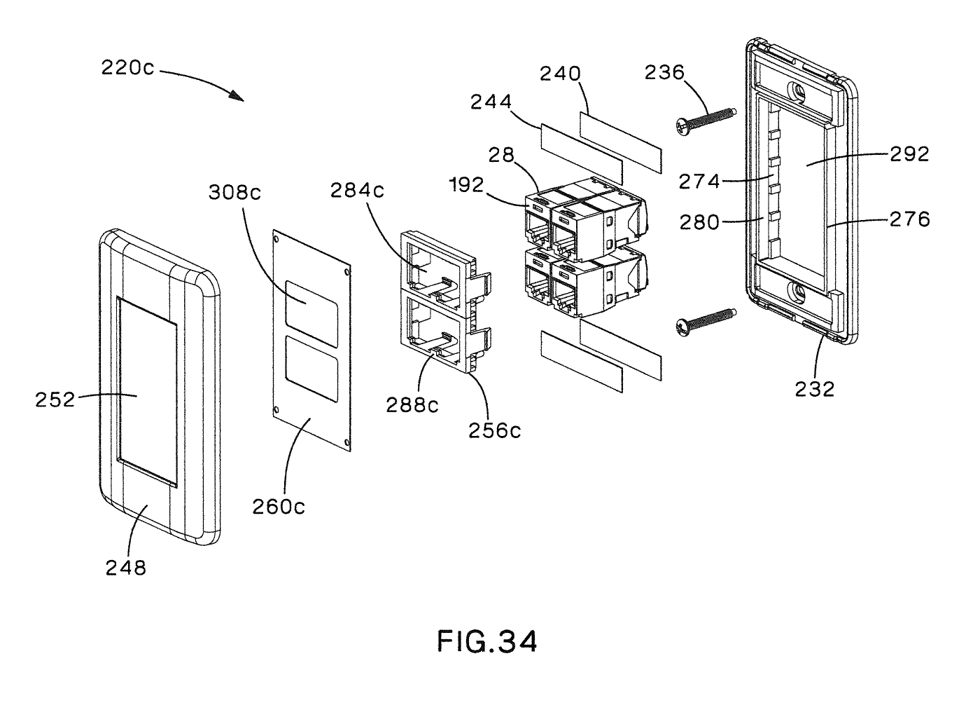

Referring now to FIGS. 33 and 34, the faceplate assembly 220c is adapted to support four jacks 28 and includes a plurality of module inserts 256c and another exemplary embodiment of a decorative member 260c. The faceplate assembly 220c includes the same backing member 232, fasteners 236, labels 240, label covers 244, and cover 248.

In the illustrated exemplary embodiment, the faceplate assembly 220c includes two substantially identical module inserts 256c both of which are similar to the module insert 256c described above in connection with FIGS. 29 and 30. Each module insert 256c includes two ports adapted to receive two jacks 28 resulting in the faceplate assembly 220c supporting a total of four jacks 28. When the jacks 28 are coupled to the inserts 256c, front surfaces 192 of the jacks 28 are substantially flush with front surfaces 288c of the inserts 256c.

In the illustrated exemplary embodiment, each insert 256c is about one-third the size of the jack aperture 292 defined in the backing member 232. As indicated above, the jack aperture 292 includes five recesses 274 in each of the right and left edges 276, 280 of the jack aperture 292. Thus, the two inserts 256c may be inserted into the jack aperture 292 and coupled to the backing member 232 in several different positions.

As illustrated in FIGS. 33 and 34, the group of four jacks 28 will be centered vertically and horizontally within the faceplate assembly 220c when the inserts 256c are coupled to the backing member 232.

With continued reference to FIGS. 33 and 34, the decorative member 260c defines two module openings 308c therein that are adapted to align with the module openings 284c in the two inserts 256c and the front surfaces 192 of the four jacks 28. In the illustrated exemplary embodiment, the module openings 308c in the decorative member 260c are sized and shaped to accommodate the four jacks 28. As indicated above, a desirable aspect of the faceplate assembly 220c is to provide an aesthetically pleasing faceplate assembly 220c that horizontally and vertically centers the connectivity module(s). Thus, with the four jacks 28 centrally located as shown in the illustrated exemplary embodiment, the module openings 308c in the decorative member 260c are also centrally located to align with the centrally located jacks 28. The decorative member 260c may be coupled to the cover 248 in all the same manners and may have all the same characteristics as the decorative member 260 described above in connection with FIGS. 26-28.

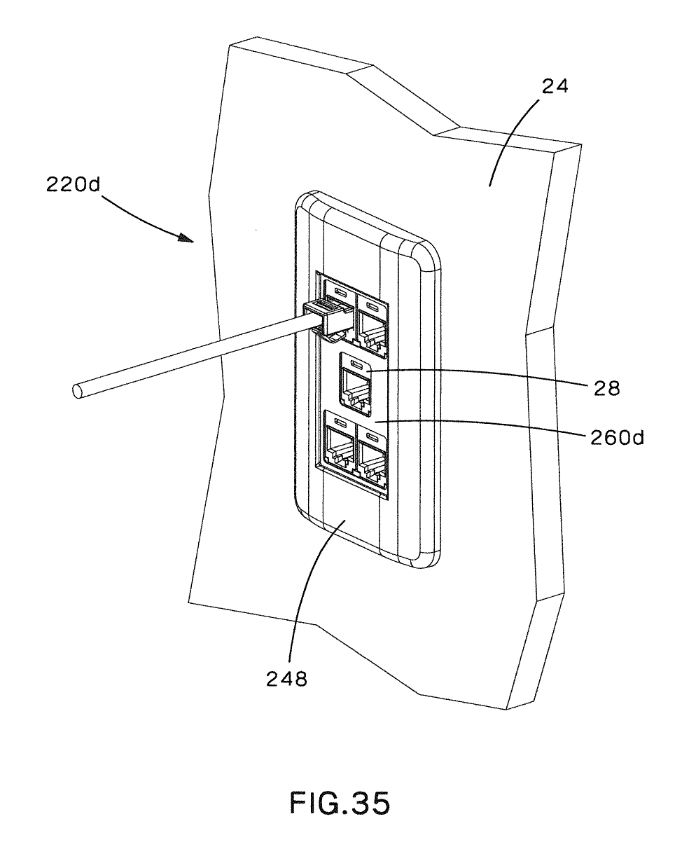

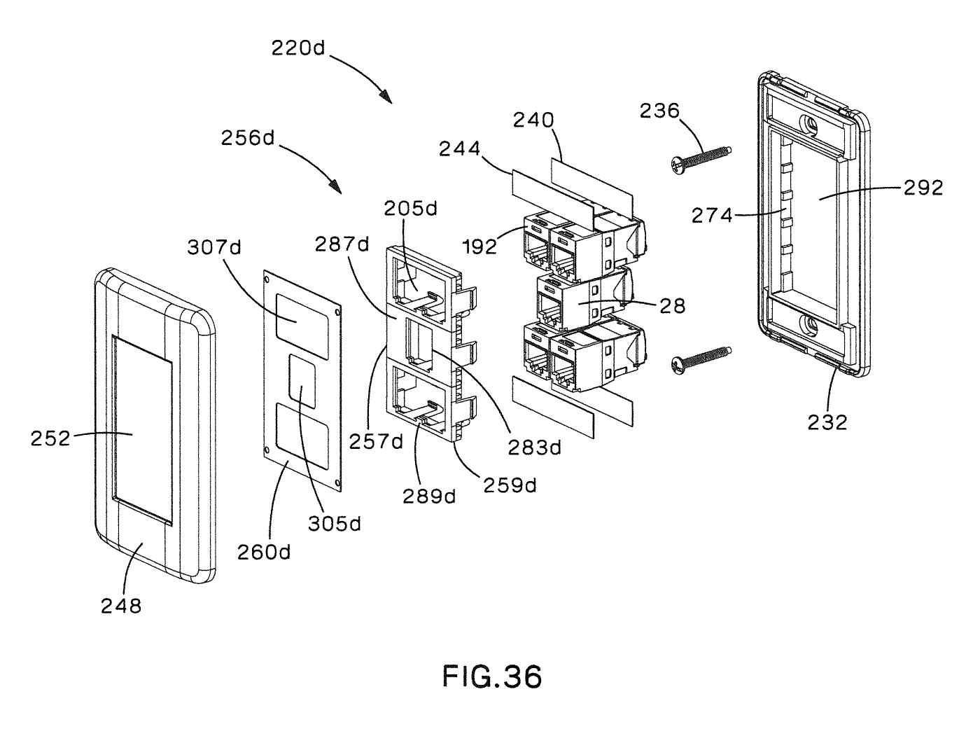

Referring now to FIGS. 35 and 36, the faceplate assembly 220d is adapted to support five jacks 28 and includes a plurality of module inserts 256d and another exemplary embodiment of a decorative member 260d. The faceplate assembly 220d includes backing member 232, fasteners 236, labels 240, label covers 244, and cover 248.

In the illustrated exemplary embodiment, the faceplate assembly 220d includes three module inserts 256d with a first module insert 257d similar to the module insert 256 described above in connection with FIGS. 26-28, and second and third substantially identical module inserts 259d both of which are similar to the module insert 256a described above in connection with FIGS. 29 and 30. The first module insert 257d includes a single port adapted to receive one jack 28, and the second and third module inserts 259d each include two ports adapted to receive two jacks 28 resulting in the faceplate assembly 220d supporting a total of five jacks 28. When the jacks 28 are coupled to the inserts 256d, front surfaces 192 of the jacks 28 are substantially flush with front surfaces 287d, 289d of the inserts 256d.

Each insert 256d is about one-third the size of the jack aperture 292 defined in the backing member 232.

As illustrated in FIGS. 35 and 36, the group of five jacks 28 will be centered vertically and horizontally within the faceplate assembly 220d when the inserts 256d are coupled to the backing member 232 with the first module insert 257d coupled to the backing member 232 in a center set of recesses 274, the second module insert 259d coupled to the backing member 232 in a top set of recesses 274, and the third module insert 259d coupled to the backing member 232 in a bottom set of recesses 274.

With continued reference to FIGS. 35 and 36, the decorative member 260d defines module openings 305d, 307d therein that are adapted to align with the module openings 283d, 285d in the inserts 257d, 259d, respectively, and the front surfaces 192 of the five jacks 28. In the illustrated exemplary embodiment, the module openings 305d, 307d in the decorative member 260d are sized and shaped to accommodate the five jacks 28. As indicated above, a desirable aspect of the faceplate assembly 220d is to provide an aesthetically pleasing faceplate assembly 220d that horizontally and vertically centers the connectivity module(s). Thus, with the five jacks 28 centrally located as shown in the illustrated exemplary embodiment, the module openings 305d, 307d in the decorative member 260d are also centrally located to align with the centrally located jacks 28. The decorative member 260d may be coupled to the cover 248 in all the same manners and may have all the same characteristics as the decorative member 260 described above in connection with FIGS. 26-28.

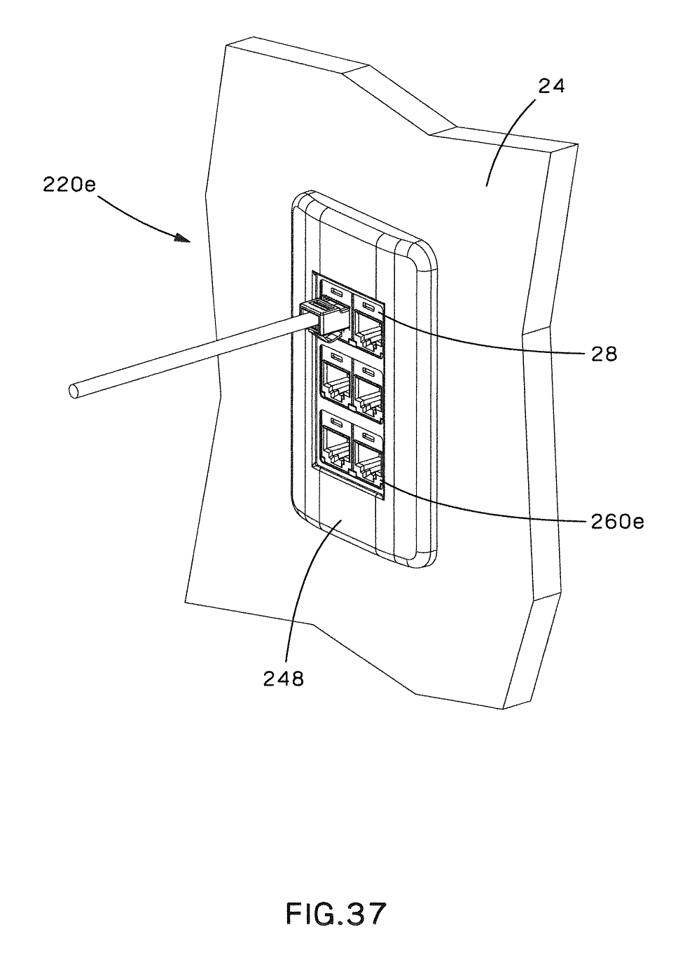

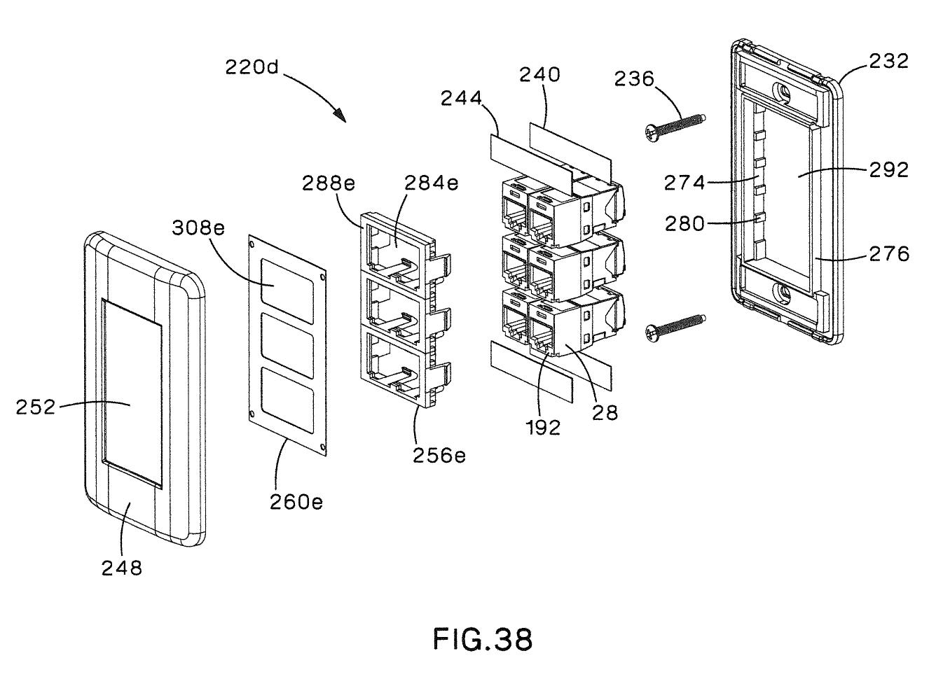

Referring now to FIGS. 37 and 38, the faceplate assembly 220e is adapted to support six jacks 28 and includes a plurality of module inserts 256e and another exemplary embodiment of a decorative member 260e. The faceplate assembly 220e includes backing member 232, fasteners 236, labels 240, label covers 244, and cover 248.

In the illustrated exemplary embodiment, the faceplate assembly 220e includes three substantially identical module inserts 256e similar to the module insert 256a described above in connection with FIGS. 29 and 30. The three module inserts 256e each include two ports adapted to receive two jacks 28 resulting in the faceplate assembly 220e supporting a total of six jacks 28. When the jacks 28 are coupled to the inserts 256e, front surfaces 192 of the jacks 28 are substantially flush with front surfaces 288e of the inserts 256e.

In the illustrated exemplary embodiment, each insert 256e is about one-third the size of the jack aperture 292 defined in the backing member 232. As indicated above, the jack aperture 292 includes five recesses 274 in each of the right and left edges 276, 280 of the jack aperture 292. Thus, the three inserts 256e may be inserted into the jack aperture 292 and coupled to the backing member 232.

As illustrated in FIGS. 37 and 38, the group of six jacks 28 will be centered vertically and horizontally within the faceplate assembly 220e when the inserts 256e are coupled to the backing member 232.

With continued reference to FIGS. 37 and 38, the decorative member 260e defines three module openings 308e therein that are adapted to align with the module openings 284e in the three inserts 256e and the front surfaces 192 of the six jacks 28. In the illustrated exemplary embodiment, the module openings 308e in the decorative member 260e are sized and shaped to accommodate the six jacks 28. As indicated above, a desirable aspect of the faceplate assembly 220e is to provide an aesthetically pleasing faceplate assembly 220e that horizontally and vertically centers the connectivity module(s). Thus, with the six jacks 28 centrally located as shown in the illustrated exemplary embodiment, the module openings 308e in the decorative member 260e are also centrally located to align with the centrally located jacks 28. The decorative member 260e may be coupled to the cover 248 in all the same manners and may have all the same characteristics as the decorative member 260 described above in connection with FIGS. 26-28.

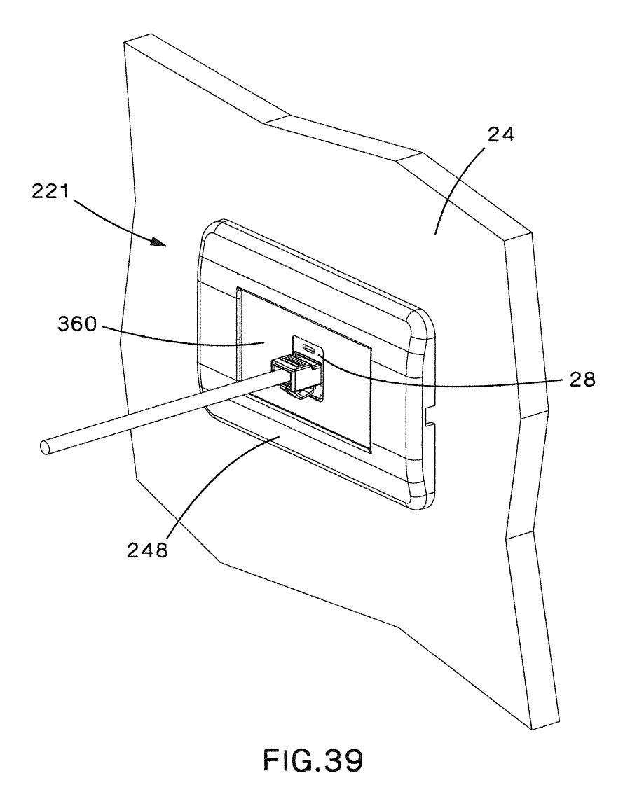

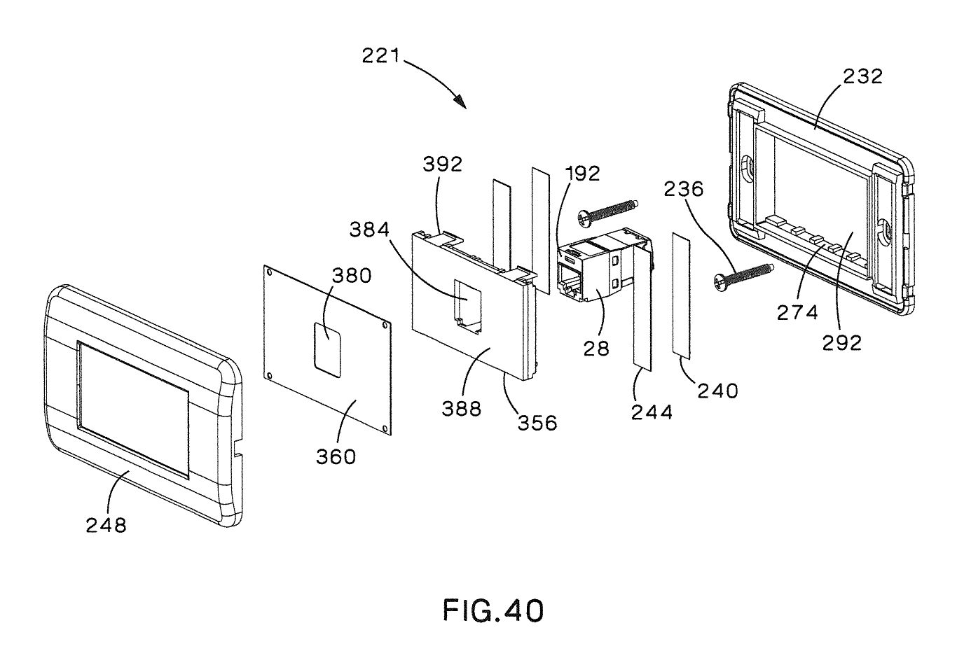

The faceplate assembly 220 is also adapted to support varying quantities of connectivity modules 28 in orientations other than vertical (see FIGS. 26-38). For example, with reference to FIGS. 39 and 40, the faceplate assembly 221 is adapted to support a single connectivity module 28 when the faceplate assembly 221 is in a horizontal orientation. The faceplate assembly 221 is adapted to support quantities of jacks 28 in a horizontal configuration.

With continued reference to FIGS. 39 and 40, the faceplate assembly 221 includes another exemplary embodiment of a module insert 356 and another exemplary embodiment of a decorative member 360. The faceplate assembly 221 also includes backing member 232, fasteners 236, labels 240, label covers 244, and cover 248, and the backing member 232 may be coupled to a horizontally orientated electrical box (not shown) with the fasteners 236. In this horizontal orientation of the faceplate assembly 221, the single jack 28 is oriented similarly to the jacks 28 described above in connection with FIGS. 26-38. That is, the jack 28 illustrated in FIGS. 39 and 40 is not turned horizontal like the faceplate assembly 221.

In the illustrated exemplary embodiment, the faceplate assembly 221 includes a module insert 356 including a single module opening 384 defined therethrough including a single port for receiving a single jack 28. When the jack 28 is coupled to the insert 356, a front surface 192 of the jack 28 is substantially flush with a front surface 388 of the insert 356.

In the illustrated exemplary embodiment, the insert 356 is substantially the same size as the jack aperture 292 defined in the backing member 232 and includes two pairs of connection members 392 similar to connection members 294 described in earlier embodiments. The two pairs of connection members 392 insert into the two sets of recesses 274 aligned with the connection members 392 and couple the insert 356 to the backing member 232. Alternatively, the module insert 356 may be a different size than that illustrated in FIGS. 39 and 40. For example, the module insert 356 may be about one-third the size of the jack aperture 292 defined in the backing member 232 and such an alternative module insert 356 may be coupled to the backing member 232 in any of the five sets of recesses 274.

As illustrated in FIGS. 39 and 40, the single jack 28 will be centered vertically and horizontally within the faceplate assembly 221 when the insert 356 is coupled to the backing member 232.

With continued reference to FIGS. 39 and 40, the decorative member 360 defines a single module opening 380 therein that is adapted to align with the module opening 384 in the insert 356 and the front surface 192 of the single jack 28. In the illustrated exemplary embodiment, the module opening 380 in the decorative member 360 is sized and shaped to accommodate the single jack 28. As indicated above, a desirable aspect of the faceplate assembly 221 is to provide an aesthetically pleasing faceplate assembly 221 that horizontally and vertically centers the connectivity module(s). Thus, with the single jack 28 centrally located as shown in the illustrated exemplary embodiment, the module opening 380 in the decorative member 360 is also centrally located to align with the centrally located jack 28. The decorative member 360 may be coupled to the cover 248 in all the same manners and may have all the same characteristics as the decorative member 260 described above in connection with FIGS. 26-28.

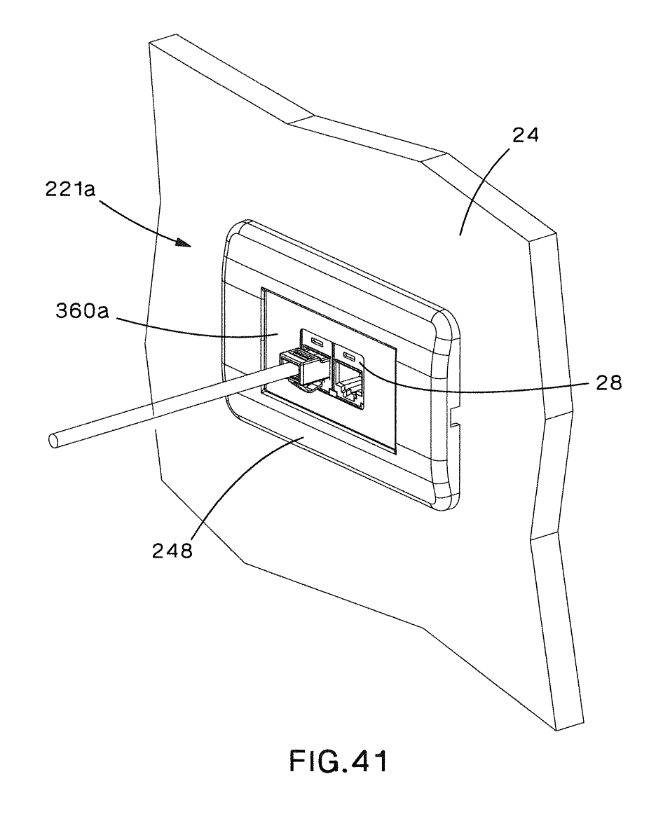

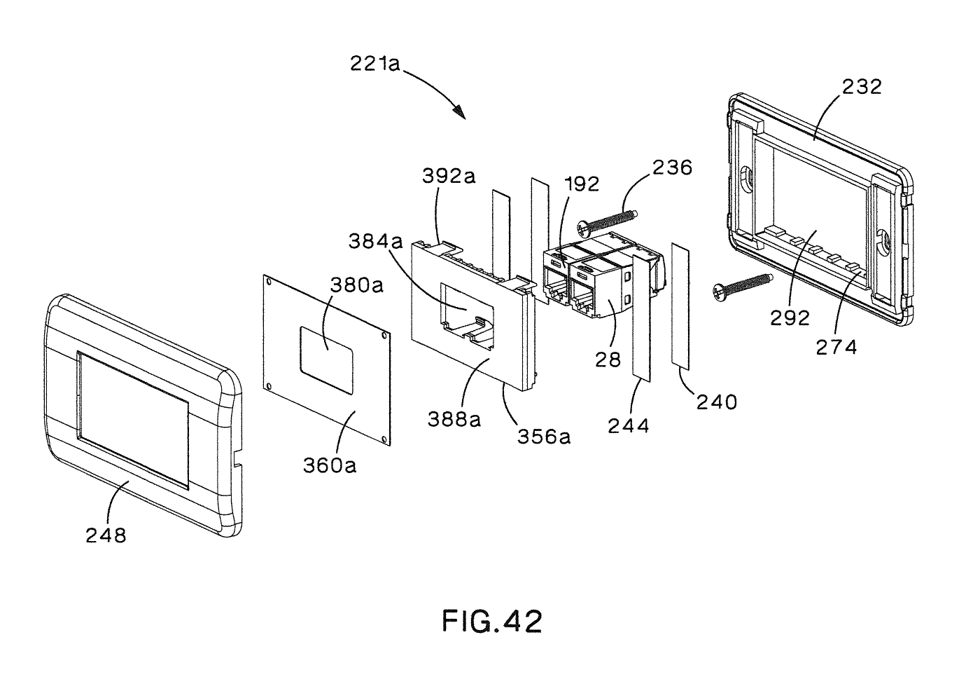

Referring now to FIGS. 41 and 42, the faceplate assembly 221a is illustrated in a horizontal orientation and is adapted to support two jacks 28 in the horizontal orientation.

With continued reference to FIGS. 41 and 42, the faceplate assembly 221a includes another exemplary embodiment of a module insert 356a and another exemplary embodiment of a decorative member 360a. The faceplate assembly 221a also includes backing member 232, fasteners 236, labels 240, label covers 244, and cover 248, and the backing member 232 may be coupled to a horizontally orientated electrical box (not shown) with the fasteners 236.

In the illustrated exemplary embodiment, the faceplate assembly 221a includes a module insert 356a including a single module opening 384a defined therethrough including two ports for receiving two jacks 28 therein. When the jacks 28 are coupled to the insert 356a, front surfaces 192 of the jacks 28 are substantially flush with a front surface 388a of the insert 356a.

In the illustrated exemplary embodiment, the insert 356a is substantially the same size as the jack aperture 292 defined in the backing member 232 and includes two pairs of connection members 392a. The two pairs of connection members 392a insert into the two sets of recesses 274 aligned with the connection members 392a and couple the insert 356a to the backing member 232.

As illustrated in FIGS. 41 and 42, the two jacks 28 will be centered vertically and horizontally within the faceplate assembly 221a when the insert 356a is coupled to the backing member 232.

With continued reference to FIGS. 41 and 42, the decorative member 360a defines a single module opening 380a therein that is adapted to align with the module opening 384a in the insert 356a and the front surfaces 192 of the two jacks 28. In the illustrated exemplary embodiment, the module opening 380a in the decorative member 360a is sized and shaped to accommodate the two jacks 28. As indicated above, a desirable aspect of the faceplate assembly 221a is to provide an aesthetically pleasing faceplate assembly 221a that horizontally and vertically centers the connectivity module(s). Thus, with the two jacks 28 centrally located as shown in the illustrated exemplary embodiment, the module opening 380a in the decorative member 360a is also centrally located to align with the centrally located jacks 28. The decorative member 360a may be coupled to the cover 248 in all the same manners and may have all the same characteristics as the decorative member 260 described above in connection with FIGS. 26-28.

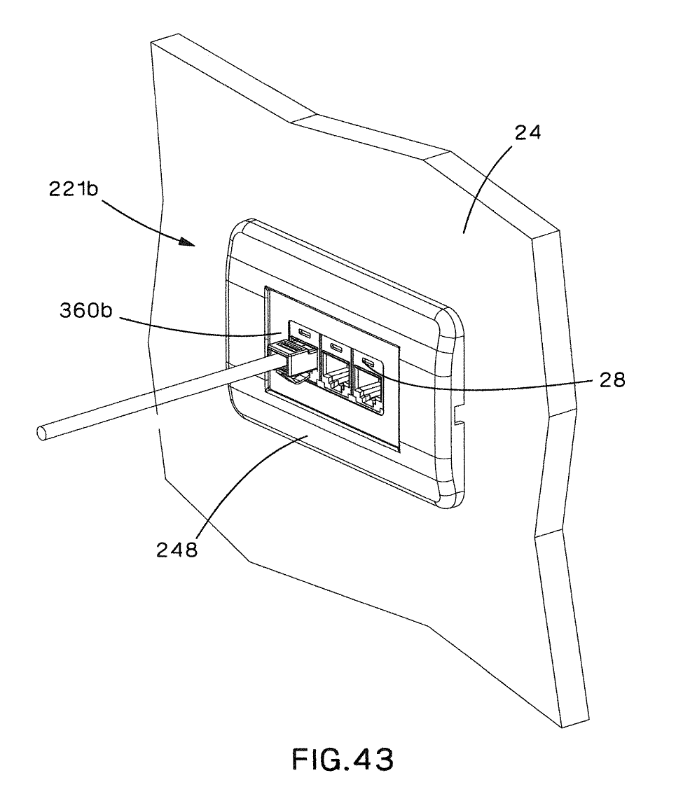

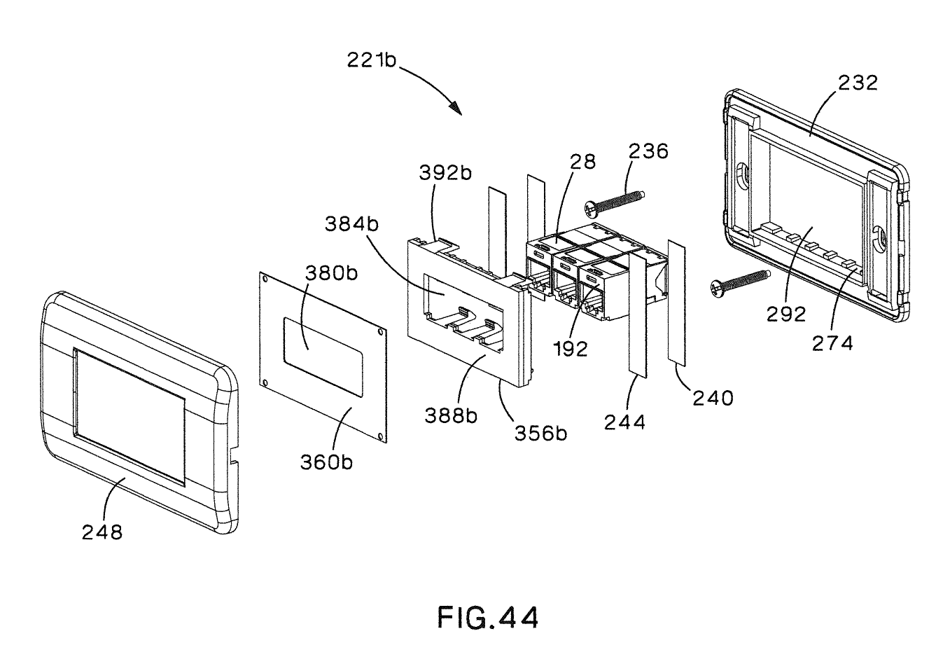

Referring now to FIGS. 43 and 44, the faceplate assembly 221b is illustrated in a horizontal orientation and is adapted to support three jacks 28 in the horizontal orientation.

With continued reference to FIGS. 43 and 44, the faceplate assembly 221b includes another exemplary embodiment of a module insert 356b and another exemplary embodiment of a decorative member 360b. The faceplate assembly 221b also includes backing member 232, fasteners 236, labels 240, label covers 244, and cover 248 with the backing member 232 coupled to a horizontally orientated electrical box (not shown) with the fasteners 236.

In the illustrated exemplary embodiment, the faceplate assembly 221b includes a module insert 356b including a single module opening 384b defined therethrough including three ports for receiving three jacks 28. When the jacks 28 are coupled to the insert 356b, front surfaces 192 of the jacks 28 are substantially flush with a front surface 388b of the insert 356b.

In the illustrated exemplary embodiment, the insert 356b is substantially the same size as the jack aperture 292 defined in the backing member 232 and includes two pairs of connection members 392b. The two pairs of connection members 392b insert into the two sets of recesses 274 aligned with the connection members 392b and couple the insert 356b to the backing member 232.

As illustrated in FIGS. 43 and 44, the three jacks 28 will be centered vertically and horizontally within the faceplate assembly 221b when the insert 356b is coupled to the backing member 232.

With continued reference to FIGS. 43 and 44, the decorative member 360b defines a single module opening 380b therein that is adapted to align with the module opening 384b in the insert 356b and the front surfaces 192 of the three jacks 28. In the illustrated exemplary embodiment, the module opening 380b in the decorative member 360b is sized and shaped to accommodate the three jacks 28. As indicated above, a desirable aspect of the faceplate assembly 221b is to provide an aesthetically pleasing faceplate assembly 221b that horizontally and vertically centers the connectivity module(s). Thus, with the three jacks 28 centrally located as shown in the illustrated exemplary embodiment, the module opening 380b in the decorative member 360b is also centrally located to align with the centrally located jacks 28. The decorative member 360b may be coupled to the cover 248 in all the same manners and may have all the same characteristics as the decorative member 260 described above in connection with FIGS. 26-28.

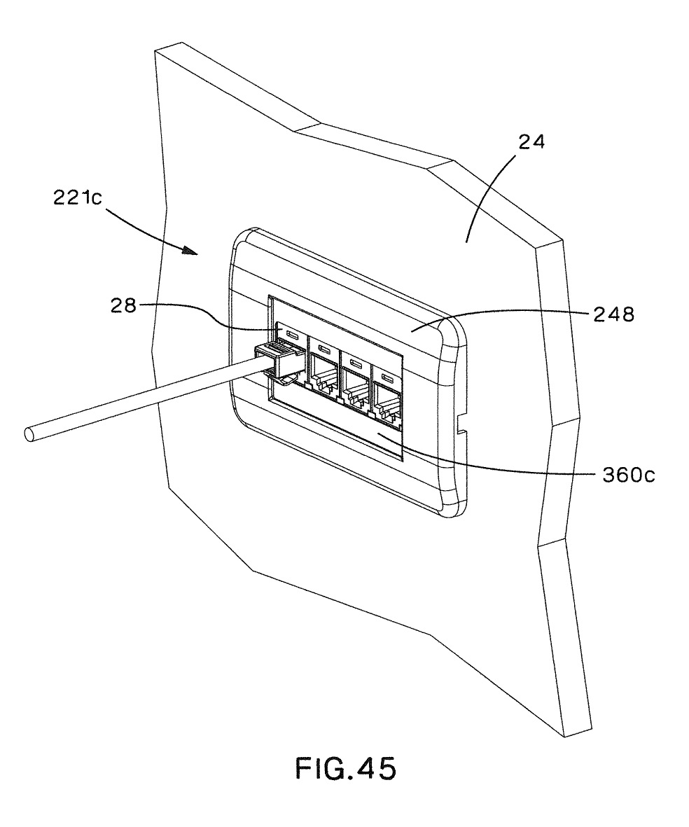

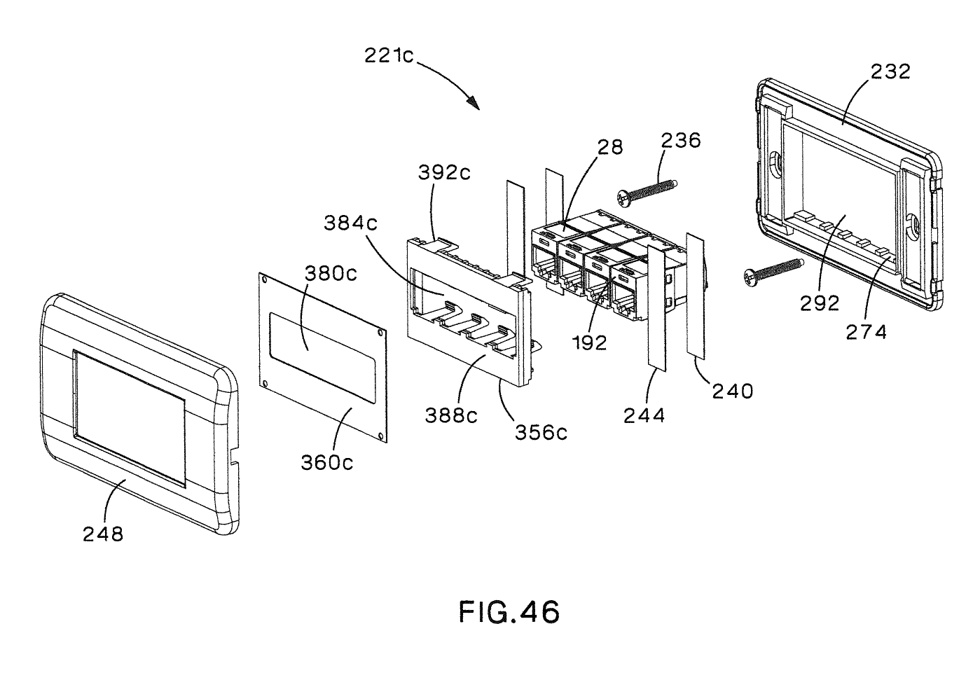

Referring now to FIGS. 45 and 46, the faceplate assembly 221c is illustrated in a horizontal orientation and is adapted to support four jacks 28 in the horizontal orientation.

With continued reference to FIGS. 45 and 46, the faceplate assembly 221c includes another exemplary embodiment of a module insert 356c and another exemplary embodiment of a decorative member 360c. The faceplate assembly 221c also includes backing member 232, fasteners 236, labels 240, label covers 244, and cover 248 with the backing member 232 adapted to couple to a horizontally orientated electrical box (not shown) with the fasteners 236.

In the illustrated exemplary embodiment, the faceplate assembly 221c includes a module insert 356c including a single module opening 384c defined therethrough including four ports for receiving four jacks 28 therein. When the jacks 28 are coupled to the insert 356c, front surfaces 192 of the jacks 28 are substantially flush with a front surface 388c of the insert 356c.

In the illustrated exemplary embodiment, the insert 356c is substantially the same size as the jack aperture 292 defined in the backing member 232 and includes two pairs of connection members 392c. The two pairs of connection members 392c insert into the two sets of recesses 274 aligned with the connection members 392c and couple the insert 356c to the backing member 232.

As illustrated in FIGS. 45 and 46, the four jacks 28 will be centered vertically and horizontally within the faceplate assembly 221c when the insert 356c is coupled to the backing member 232.

With continued reference to FIGS. 45 and 46, the decorative member 360c defines a single module opening 380c therein that is adapted to align with the module opening 384c in the insert 356c and the front surfaces 192 of the four jacks 28. In the illustrated exemplary embodiment, the module opening 380c in the decorative member 360c is sized and shaped to accommodate the four jacks 28. As indicated above, a desirable aspect of the faceplate assembly 221c is to provide an aesthetically pleasing faceplate assembly 221c that horizontally and vertically centers the connectivity module(s). Thus, with the four jacks 28 centrally located as shown in the illustrated exemplary embodiment, the module opening 380c in the decorative member 360c is also centrally located to align with the centrally located jacks 28. The decorative member 360c may be coupled to the cover 248 in all the same manners and may have all the same characteristics as the decorative member 260 described above in connection with FIGS. 26-28.

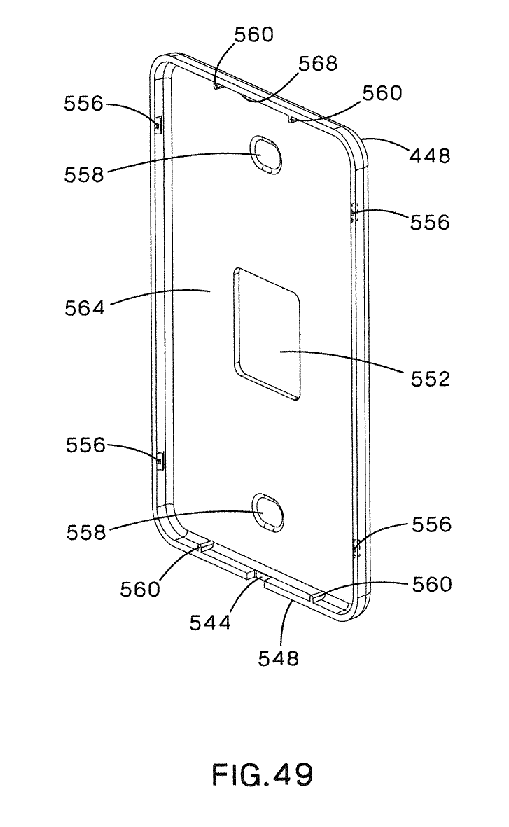

Referring now to FIGS. 47-49, the faceplate assembly 420 includes a backing member 432, a plurality of fasteners 436, two labels 440, two label covers 444, and a cover 448. The backing member 432 and the cover 448 may each be constructed as a single unitarily formed piece of plastic. Additionally, the backing member 432 and the cover 448 may be injection molded. The backing member 432 may be coupled to an electrical box 52 coupled to the surface 24. A standard electrical box 52 includes two flanges 56 with each flange 56 including an aperture 60 therein. The fasteners 436 are used to couple the backing member 432 to the flanges 56 of the electrical box 52 via the apertures 60 in the flanges 56.

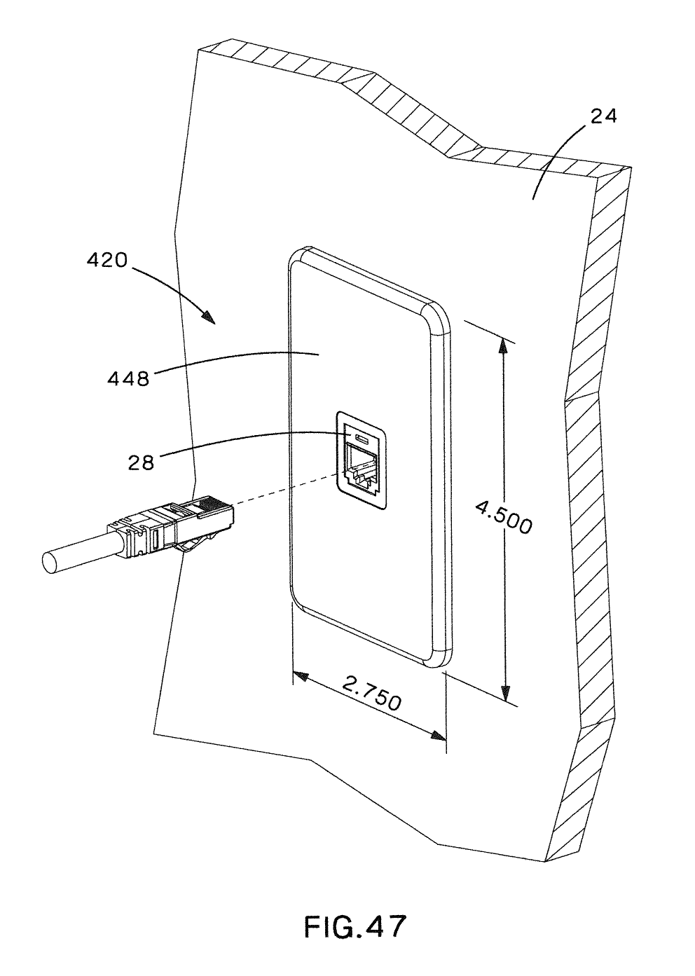

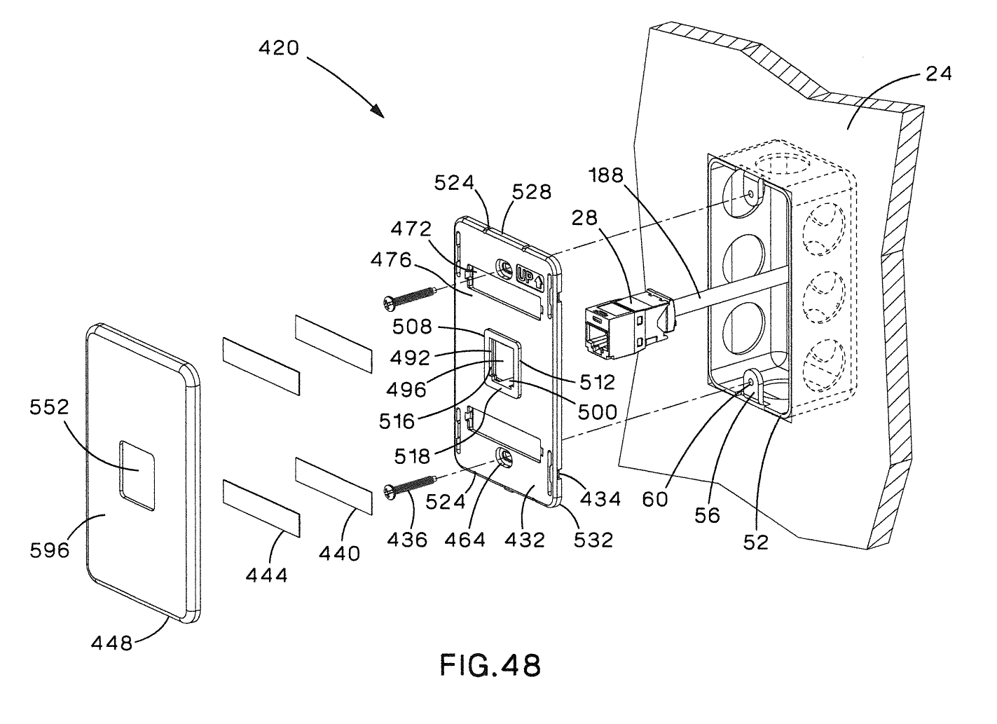

With particular reference to FIG. 48, the backing member 432 includes a pair of mounting holes 464 that may be aligned with apertures 60 in an electrical box 52 and through which the fasteners 436 may be inserted to couple the backing member 432 to the electrical box 52. In some exemplary embodiments, the mounting holes 464 may be recessed to inhibit the fasteners 436 from projecting out of the mounting holes 464 when coupled to the electrical box 52. In other exemplary embodiments, the fasteners 436 may slightly project out of the mounting holes 464. The backing member 432 also includes a pair of label receptacles 472 defined therein for receiving labels 440. Label covers 444 may be introduced into the label receptacles 472 subsequent to introduction of the labels 440 into the label receptacles 472 to cover and protect the labels 440 and capture the labels 440 between the label covers 444 and bottoms of the label receptacles 472 to secure the labels 440 in place. The label covers 444 are manufactured of a transparent or translucent material to enable an individual to see through the label covers 444 and read any indicia located on the labels 440. The label receptacles 472 are sufficiently deep to inhibit the labels 440 and label covers 444 from projecting outward of the label receptacles 472. The backing member 432 further includes a plurality of flexible latches 434 for coupling the cover 448 to the backing member 432.

With continued reference to FIG. 48, the backing member 432 defines a jack aperture 492 therethrough including a single port 496 for receiving a single jack 28. The backing member 432 also includes a hook latch 500 for coupling the single jack 28 to the backing member 432. The hook latch 500 may be similar to the hook latches 100 described above in connection with FIGS. 1-7. A plurality of slots 524 are defined in the backing member 432 to assist with alignment and proper coupling of the cover 448 to the backing member 432. In the illustrated exemplary embodiment, first and second slots 524 are defined in a top edge 528 of the backing member 432 and third and fourth slots 524 are defined in a bottom edge 532 of the backing member 432. The backing member 432 further includes a border 508 extending around the jack aperture 492 and projecting outward from a front surface 476 of the backing member 432. In the illustrated exemplary embodiment, the border 508 has a generally rectangular outer edge 512 and an inner edge 516 that complements the shape of the jack aperture 492.

Referring now to FIGS. 47-49, the cover 448 defines an opening 552 therethrough sized and shaped to receive the border 508 on the backing member 432 and the single jack 28. The cover 448 further includes a plurality of rigid latches 556 engageable with the flexible latches 434 included on the backing member 432 to couple the cover 448 to the backing member 432. The cover 448 may also include a pair of receptacles 558 aligned with the mounting holes 464 and the fasteners 436 when in use to couple the backing member 432 to the electrical box 52. The receptacles 558 receive heads of the fasteners 436 therein if the fasteners 436 project outwardly of the mounting holes 464. The cover 448 further includes a release slot 544 in a bottom edge 548 thereof to facilitate removal of the cover 448 from the backing member 432. A screwdriver or other device may be inserted into the release slot 544 and manipulated to remove the cover 448 from the backing member 432.

The cover 448 further includes a plurality of projections 560 to assist with proper alignment of the cover 448 when connecting the cover 448 to the backing member 432. In the illustrated exemplary embodiment, the cover 448 includes four projections 560. First and second projections 560 are positioned on an interior top edge 568 of the cover 448 and third and fourth projections 560 are positioned on an interior bottom edge 548 of the cover 448.

When coupling the cover 448 to the backing member 432, the opening 552 in the cover 448 is aligned with the border 508 on the backing member 432 and the projections 560 on the cover 448 are aligned with the slots 524 in the backing member 432. The cover 448 is moved toward the backing member 432 sliding the border 508 on the backing member 432 into the opening 552 in the cover 448 and sliding the projections 560 on the cover 448 into the slots 524 in the backing member 432 until the rigid latches 556 on the cover 448 engage and couple to the flexible latches 434 on the backing member 432. The receptacles 558 in the interior surface 564 of the cover 448 receive heads of the fasteners 436 if the fasteners 436 protrude outwardly of the mounting holes 464. The receptacles 558 inhibit projecting fasteners 436 from blocking the cover 448 from fully sliding onto and coupling to the backing member 432. When the cover 448 is coupled to the backing member 432, a front surface 518 of the border 508 on the backing member 432 is substantially flush with a front surface 596 of the cover 448 and the outer edge 512 of the border 508 is either very close to or may contact the edge of the opening 552 in the cover 448 to provide a substantially continuous and flat surface across the front of the faceplate assembly 420. This provides an aesthetically appealing appearance to the faceplate assembly 420. Additionally, the cover 448 covers the backing member 432, the fasteners 436, the labels 440, the label covers 444, and other components of the faceplate assembly 420 to provide an aesthetically pleasing faceplate assembly 420.

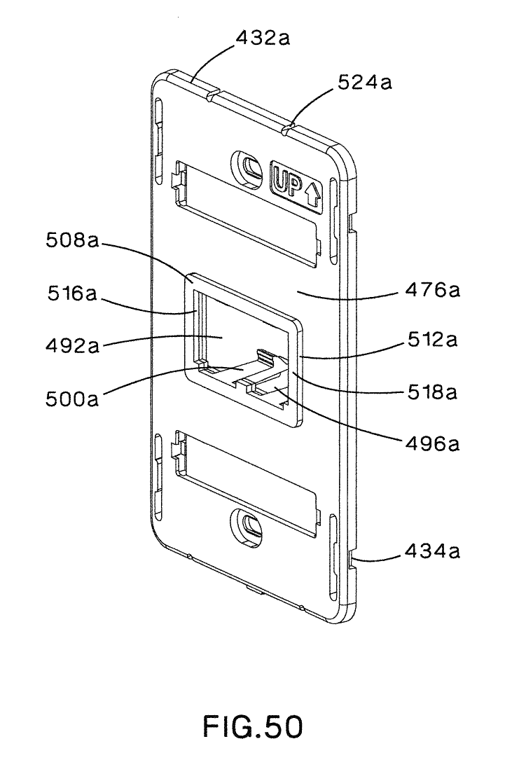

Referring now to FIGS. 50-52, the faceplate assembly 420a is shown and includes another exemplary embodiment of a backing member 432a and a cover 448a. The exemplary embodiments of the backing member 432a and the cover 448a illustrated in FIGS. 50-52 are adapted to support two jacks 28.

With particular reference to FIG. 50, the illustrated exemplary embodiment of the backing member 432a defines a jack aperture 492a therethrough including two ports 496a for receiving two jacks 28. The jack aperture 492a and ports 496a are substantially horizontally and vertically centered in the backing member 432a and are substantially horizontally and vertically centered in the faceplate assembly 420a when the cover 448a is coupled to the backing member 432a. The backing member 432a also includes a plurality of hook latches 500a for coupling the jacks 28 to the backing member 432a. The hook latches 500a may be similar to the hook latches 100 described above in connection with FIGS. 1-7. The backing member 432a further includes a border 508a extending around the jack aperture 492a and projecting outward from a front surface 476a of the backing member 432a. In the illustrated exemplary embodiment, the border 508a has a generally rectangular outer edge 512a and an inner edge 516a that complements the shape of the jack aperture 492a.

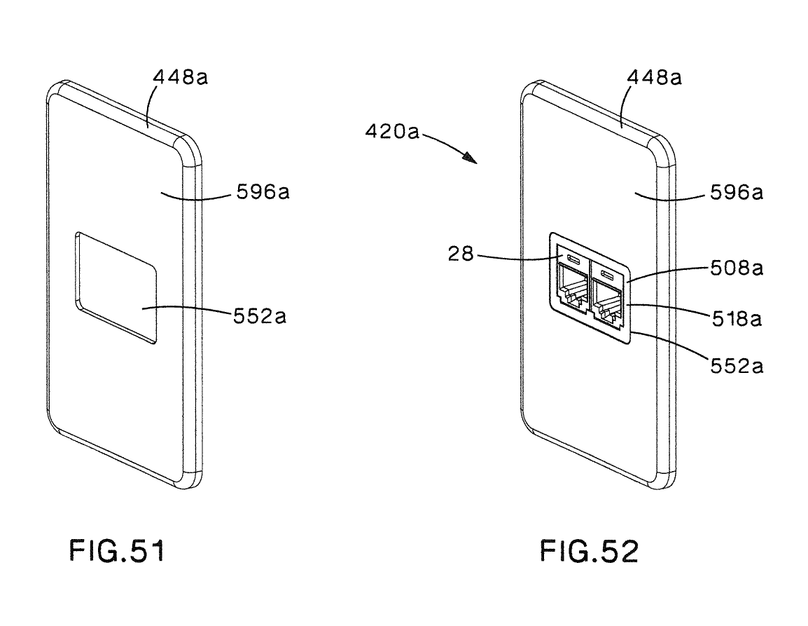

Referring now to FIGS. 51 and 52, the cover 448a defines an opening 552a therethrough sized and shaped to receive the border 508a on the backing member 432a and the two jacks 28.

When coupling the cover 448a to the backing member 432a, the opening 552a in the cover 448a is aligned with the border 508a on the backing member 432a and the projections (not illustrated) on the cover 448a are aligned with the slots 524a in the backing member 432a. The cover 448a moves toward the backing member 432a sliding the border 508a on the backing member 432a into the opening 552a in the cover 448a and sliding the projections on the cover 448a into the slots 524a in the backing member 432a until the rigid latches (not illustrated) on the cover 448a engage and couple to the flexible latches 434a on the backing member 432a. When the cover 448a is coupled to the backing member 432, a front surface 518a of the border 508a on the backing member 432a is substantially flush with a front surface 596a of the cover 448a and the outer edge 512a of the border 508a is either very close to or may contact the edge of the opening 552a in the cover 448a to provide a substantially continuous and flat surface across the front of the faceplate assembly 420a. This provides an aesthetically appealing appearance to the faceplate assembly 420a. Additionally, the cover 448a covers the backing member 432a, the fasteners 436, the labels 440, the label covers 444, and other components of the faceplate assembly 420a to provide an aesthetically pleasing faceplate assembly 420a.

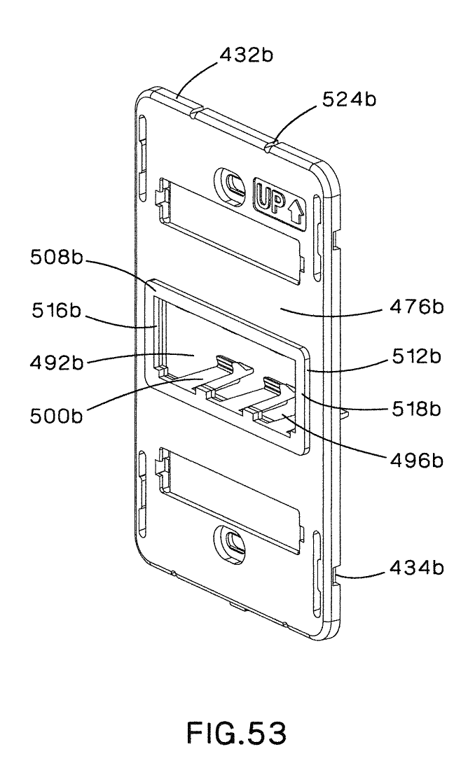

Referring now to FIGS. 53-55, the faceplate assembly 420b is shown and includes another exemplary embodiment of a backing member 432b and a cover 448b. The exemplary embodiments of the backing member 432b and the cover 448b illustrated in FIGS. 53-55 are adapted to support three jacks 28.

With particular reference to FIG. 53, the illustrated exemplary embodiment of the backing member 432b defines a jack aperture 492b therethrough including three ports 496b for receiving three jacks 28. The jack aperture 492b and ports 496b are substantially horizontally and vertically centered in the backing member 432b and are substantially horizontally and vertically centered in the faceplate assembly 420b when the cover 448b is coupled to the backing member 432b. The backing member 432b also includes a plurality of hook latches 500b for coupling the jacks 28 to the backing member 432b. The hook latches 500b may be similar to the hook latches 100 described above in connection with FIGS. 1-7. The backing member 432b further includes a border 508b extending around the jack aperture 492b and projecting outward from a front surface 476b of the backing member 432b. In the illustrated exemplary embodiment, the border 508b has a generally rectangular outer edge 512b and an inner edge 516b that complements the shape of the jack aperture 492b.

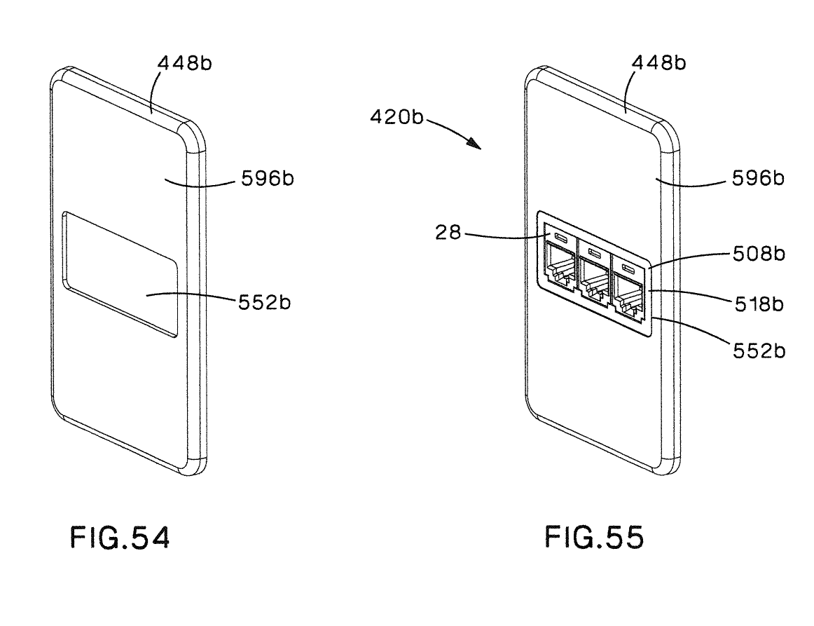

Referring now to FIGS. 54 and 55, the cover 448b defines an opening 552b therethrough sized and shaped to receive the border 508b on the backing member 432b and the three networking jacks 28.

When coupling the cover 448b to the backing member 432b, the opening 552b in the cover 448b is aligned with the border 508b on the backing member 432b and the projections (not illustrated) on the cover 448b are aligned with the slots 524b in the backing member 432b. The cover 448b is moved toward the backing member 432b sliding the border 508b on the backing member 432b into the opening 552b in the cover 448b and sliding the projections on the cover 448b into the slots 524b in the backing member 432b until the rigid latches (not illustrated) on the cover 448b engage and couple to the flexible latches 434b on the backing member 432b. When the cover 448b is coupled to the backing member 432b, a front surface 518b of the border 508b on the backing member 432b is substantially flush with a front surface 596b of the cover 448b and the outer edge 512b of the border 508b is either very close to or may contact the edge of the opening 552b in the cover 448b to provide a substantially continuous and flat surface across the front of the faceplate assembly 420b. This provides an aesthetically appealing appearance to the faceplate assembly 420b. Additionally, the cover 448b covers the backing member 432b, the fasteners 436, the labels 440, the label covers 444, and other components of the faceplate assembly 420b to provide an aesthetically pleasing faceplate assembly 420b.

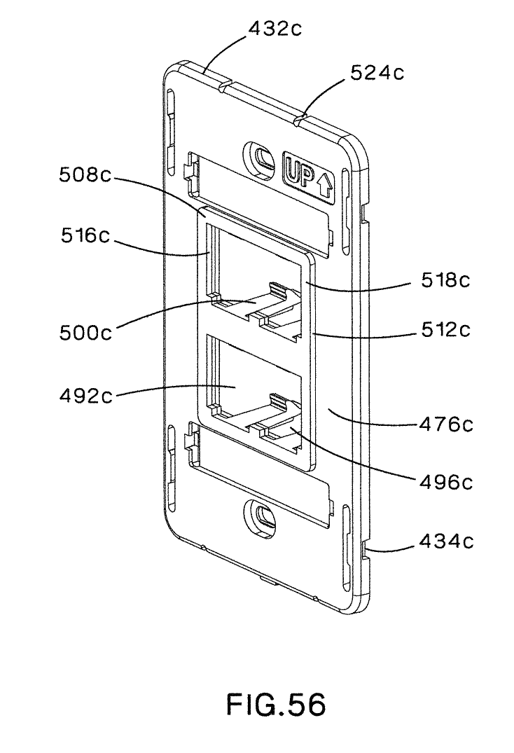

Referring now to FIGS. 56-58, the faceplate assembly 420c is shown and includes another exemplary embodiment of a backing member 432c and a cover 448c. The exemplary embodiments of the backing member 432c and the cover 448c illustrated in FIGS. 56-58 are adapted to support four jacks 28.

With particular reference to FIG. 56, the illustrated exemplary embodiment of the backing member 432c defines two jack apertures 492c therethrough with each jack aperture 492c including two ports 496c for receiving two jacks 28, thereby providing a faceplate assembly 420c for supporting a total of four jacks 28. The group of two jack apertures 492c including four ports 496c is substantially horizontally and vertically centered in the backing member 432c and is substantially horizontally and vertically centered in the faceplate assembly 420c when the cover 448c is coupled to the backing member 432c. The backing member 432c also includes a plurality of hook latches 500c for coupling the four jacks 28 to the backing member 432c. The hook latches 500c may be similar to the hook latches 100 described above in connection with FIGS. 1-7. The backing member 432c further includes a border 508c extending around and between the two jack apertures 492c and projecting outward from a front surface 476c of the backing member 432c. In the illustrated exemplary embodiment, the border 508c has a generally rectangular outer edge 512c and two inner edges 516c that complement the shapes of the two jack apertures 492c.

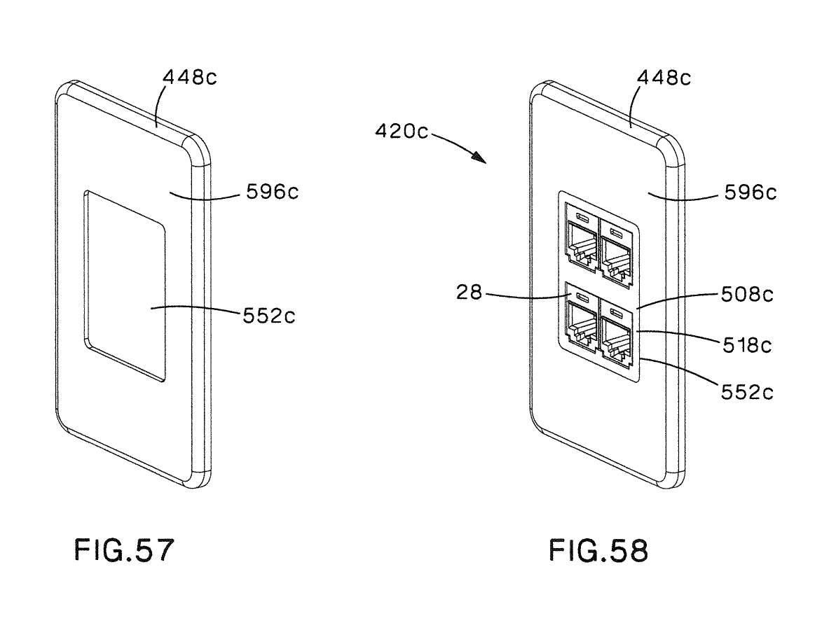

Referring now to FIGS. 57 and 58, the cover 448c defines an opening 552c therethrough sized and shaped to receive the border 508c on the backing member 432c and the four jacks 28.

When coupling the cover 448c to the backing member 432c, the opening 552c in the cover 448c is aligned with the border 508c on the backing member 432c and the projections (not illustrated) on the cover 448c are aligned with the slots 524c in the backing member 432c. The cover 448c moves toward the backing member 432c sliding the border 508c on the backing member 432c into the opening 552c in the cover 448c and sliding the projections on the cover 448c into the slots 524c in the backing member 432c until the rigid latches (not illustrated) on the cover 448c engage and couple to the flexible latches 434c on the backing member 432c. When the cover 448c is coupled to the backing member 432c, a front surface 518c of the border 508c on the backing member 432c is substantially flush with a front surface 596c of the cover 448c and the outer edge 512c of the border 508c is either very close to or may contact the edge of the opening 552c in the cover 448c to provide a substantially continuous and flat surface across the front of the faceplate assembly 420c. This provides an aesthetically appealing appearance to the faceplate assembly 420c. Additionally, the cover 448c covers the backing member 432c, the fasteners 436, the labels 440, the label covers 444, and other components of the faceplate assembly 420c to provide an aesthetically pleasing faceplate assembly 420c.

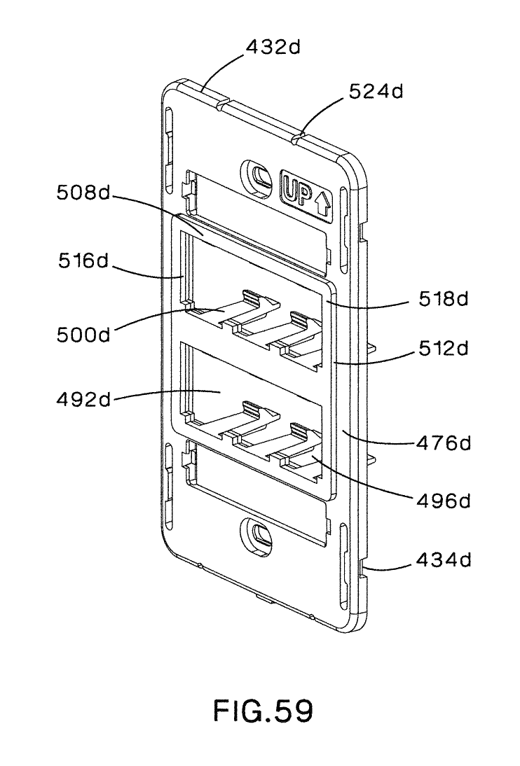

Referring now to FIGS. 59-61, the faceplate assembly 420d is shown and includes another exemplary embodiment of a backing member 432d and a cover 448d. The exemplary embodiments of the backing member 432d and the cover 448d illustrated in FIGS. 59-61 are adapted to support six jacks 28.

With particular reference to FIG. 59, the illustrated exemplary embodiment of the backing member 432d defines two jack apertures 492d therethrough with each jack aperture 492d including three ports 496d for receiving three jacks 28, thereby providing a faceplate assembly 420d for supporting a total of six jacks 28. The group of two jack apertures 492d including six ports 496d is substantially horizontally and vertically centered in the backing member 432d and is substantially horizontally and vertically centered in the faceplate assembly 420d when the cover 448d is coupled to the backing member 432d. The backing member 432d also includes a plurality of hook latches 500d for coupling the six jacks 28 to the backing member 432d. The hook latches 500d may be similar to the hook latches 100 described above in connection with FIGS. 1-7. The backing member 432d further includes a border 508d extending around and between the two jack apertures 492d and projecting outward from a front surface 476d of the backing member 432d. In the illustrated exemplary embodiment, the border 508d has a generally rectangular outer edge 512d and two inner edges 516d that complement the shapes of the two jack apertures 492d.

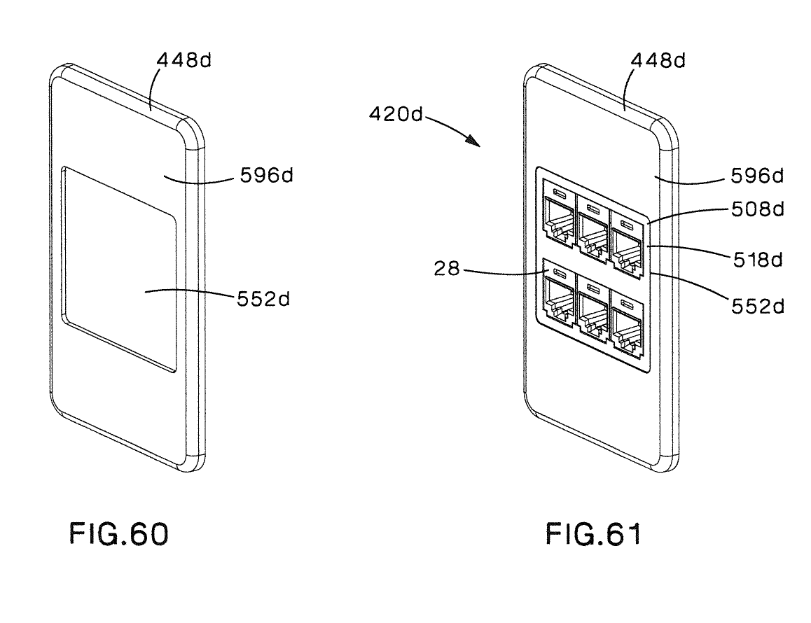

Referring now to FIGS. 60 and 61, the cover 448d defines an opening 552d therethrough sized and shaped to receive the border 508d on the backing member 432d and the six jacks 28.

When coupling the cover 448d to the backing member 432d, the opening 552d in the cover 448d is aligned with the border 508d on the backing member 432d and the projections (not illustrated) on the cover 448d are aligned with the slots 524d in the backing member 432d. The cover 448d moves toward the backing member 432d sliding the border 508d on the backing member 432d into the opening 552d in the cover 448d and sliding the projections on the cover 448d into the slots 524d in the backing member 432d until the rigid latches (not illustrated) on the cover 448d engage and couple to the flexible latches 434d on the backing member 432d. When the cover 448d is coupled to the backing member 432d, a front surface 518d of the border 508d on the backing member 432d is substantially flush with a front surface 596d of the cover 448d and the outer edge 512d of the border 508d is either very close to or may contact the edge of the opening 552d in the cover 448d to provide a substantially continuous and flat surface across the front of the faceplate assembly 420d. This provides an aesthetically appealing appearance to the faceplate assembly 420d. Additionally, the cover 448d covers the backing member 432d, the fasteners 436, the labels 440, the label covers 444, and other components of the faceplate assembly 420d to provide an aesthetically pleasing faceplate assembly 420d.

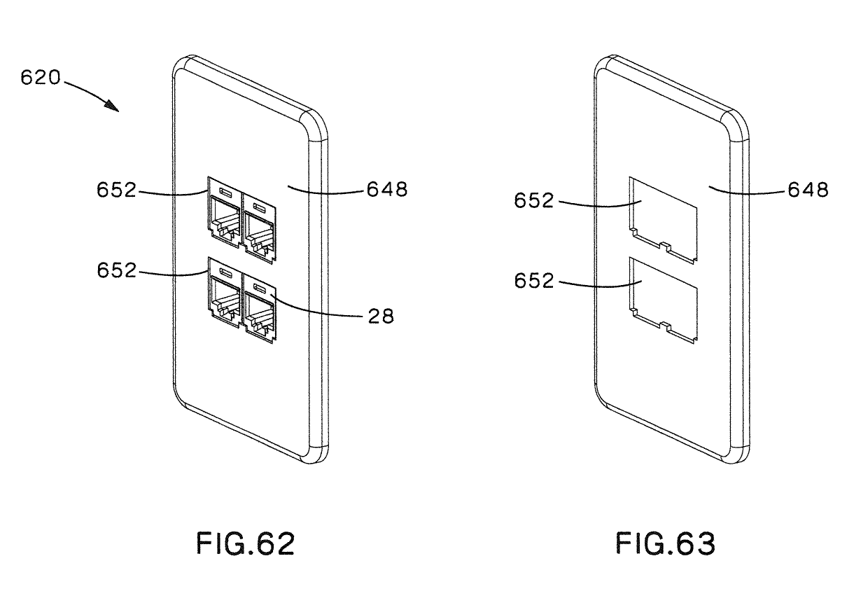

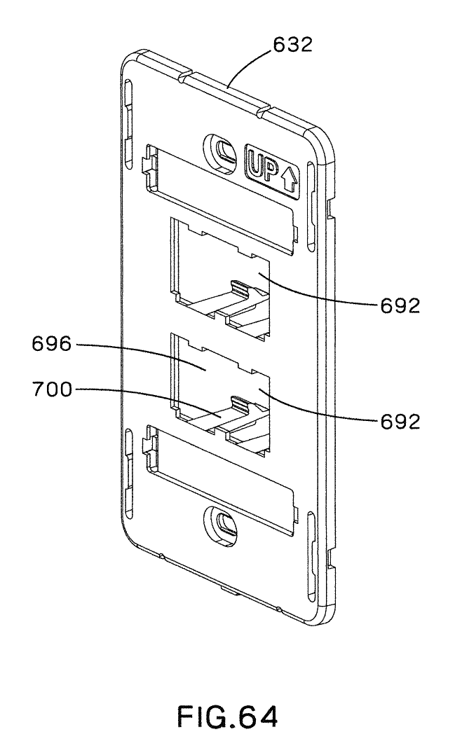

Referring now to FIGS. 62-64, a further exemplary embodiment of a faceplate assembly 620 is illustrated. The faceplate assembly 620 illustrated in FIGS. 62-64 has similarities to the faceplate assemblies illustrated in FIGS. 47-61 except the faceplate assembly 620 illustrated in FIGS. 62-64 does not include a border extending from a front surface of the backing member and the cover has a different configuration for accommodating the lack of a border on the backing member. In the illustrated exemplar embodiment, faceplate assembly 620 is adapted to support four jacks 28. However, the faceplate assembly 620 can be adapted to support any number of jacks, and accordingly the backing member may include one or more jack apertures and one or more ports.

In the illustrated exemplary embodiment, the backing member 632 includes two jack apertures 692 with each jack aperture 692 including two ports 696 for supporting two jacks 28, thereby providing a faceplate assembly 620 adapted to support a total of four jacks 28. The backing member 632 also includes a plurality of hook latches 700 for coupling the four jacks 28 to the backing member 632. The hook latches 700 may be similar to the hook latches 100 described above in connection with FIGS. 1-7.

The cover 648 defines two openings 652 therethrough each of which is sized and shaped to complement one of the jack apertures 692 and two jacks 28 positioned in the two ports 696 of the single jack aperture 692. Since the faceplate assembly 620 is adapted to support any number of connectivity modules and any type of connectivity module, the cover 648 may include any number of openings 652 defined therein having any shape to accommodate any number and type of connectivity modules.

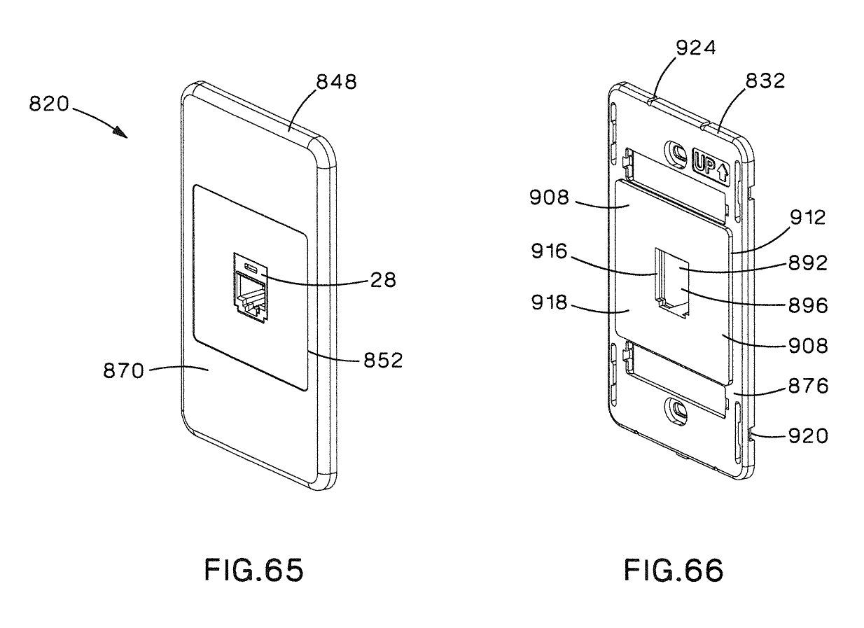

Referring now to FIGS. 65 and 66, still a further exemplary embodiment of a faceplate assembly 820 is illustrated. The faceplate assembly 820 illustrated in FIGS. 65 and 66 has similarities to the faceplate assemblies illustrated in FIGS. 47-61 except the faceplate assembly 820 illustrated in FIGS. 65 and 66 includes a common cover 848 no matter the jack density supported by the faceplate assembly 820. That is, the faceplate assembly 820 illustrated in FIGS. 65 and 66 may support any number of jacks 28 and the same cover 848 will be coupled to the backing member 832. Cover 848 is identical to the cover 448d illustrated in FIG. 60.

In the illustrated exemplar embodiment, faceplate assembly 820 is adapted to support one jack 28. The backing member 832 defines a single jack aperture 892 therethrough including a single port 896 for a single jack 28. The faceplate assembly 820 can be adapted to support any number of jacks, and accordingly the backing member 832 may include one or more jack apertures 892 and one or more ports 896 having any configuration to accommodate any number and type of jacks.

The backing member 832 further includes a border 908 extending around the jack aperture 892 and projecting outward from a front surface 876 of the backing member 832. In the illustrated exemplary embodiment, the border 908 has a generally rectangular outer edge 912 and an inner edge 916 that complements the shape of the jack aperture 892. In other exemplary embodiments of the faceplate assembly 820 accommodating different quantities of jacks 28, the outer edge 912 of the border 908 will remain the same no matter the quantity of jack apertures 892 and ports 896 defined in the backing member 832 and the quantity of jacks 28 supported in the ports 896. The inner edge 916 of the border 908, or inner edges 916 of the border 908 where multiple jack apertures 892 are defined through the backing member 832, will change to complement the shape or shapes of the one or more jack apertures 892 as the different quantities of jacks 28 are supported by the faceplate assembly 820.

Referring now to FIG. 65, the cover 848 defines an opening 852 therethrough sized and shaped to receive the border 908 on the backing member 832. Since the outer edge 912 of the border 908 will always be the same, the size of the opening 852 in the cover 848 will always remain the same no matter the quantity of jack apertures 892 and ports 896 defined in the backing member 832 and the quantity of jacks 28 supported in the ports 896. This feature allows the manufacture of fewer components to satisfy numerous jack densities in faceplate assemblies. Only one cover 848 will need to be manufactured to accommodate all jack densities of the faceplate assembly 820.

When coupling the cover 848 to the backing member 832, the opening 852 in the cover 848 is aligned with the border 908 on the backing member 932 and the projections (not illustrated) on the cover 848 are aligned with the slots 924 in the backing member 832. The cover 848 moves toward the backing member 832 sliding the border 908 on the backing member 832 into the opening 852 in the cover 848 and sliding the projections on the cover 848 into the slots 924 in the backing member 832 until the rigid latches (not illustrated) on the cover 848 engage and couple to the flexible latches 920 on the backing member 832. When the cover 848 is coupled to the backing member 832, a front surface 918 of the border 908 on the backing member 832 is substantially flush with a front surface 870 of the cover 848 and the outer edge 912 of the border 908 is either very close to or may contact the edge of the opening 852 in the cover 848 to provide a substantially continuous and flat surface across the front of the faceplate assembly 820. This provides an aesthetically appealing appearance to the faceplate assembly 820. Additionally, the cover 848 covers the backing member 832, the fasteners, the labels, the label covers, and other components of the faceplate assembly 820 to provide an aesthetically pleasing faceplate assembly 820.

The foregoing description has been presented for purposes of illustration and description, and is not intended to be exhaustive or to limit the invention to the precise form disclosed. The descriptions were selected to explain the principles of the invention and their practical application to enable others skilled in the art to utilize the invention in various embodiments and various modifications as are suited to the particular use contemplated. Although particular constructions of the present invention have been shown and described, other alternative constructions will be apparent to those skilled in the art and are within the intended scope of the present invention.

1. A faceplate assembly, comprising:
a backing plate having an opening for receiving a plurality of modules; and
a plurality of cover plates each having an approximately centered opening corresponding to a unique quantity of said modules, each of said cover plates mountable to said backing plate.

2. The faceplate assembly of claim 1, wherein said opening of said backing plate can receive at least six said modules.

3. The faceplate assembly of claim 1, wherein any of one, two, three, four, five and six modules are configurable within said faceplate assembly.

4. A faceplate assembly, comprising:
a backing plate having an opening for receiving a plurality of inserts;
a plurality of said inserts, each of said inserts configured for holding a different quantity of modules and mountable to said backing plate;
a plurality of decorative plates where each said decorative plate includes at least one opening for a unique combination of said inserts, a respective said at least one opening approximately centered within a respective said decorative plate, each of said plurality of decorative plates mountable to said backing plate; and
a cover plate mountable to said backing plate, said cover plate including an opening for exposing at least part of a respective said decorative plate and an aperture of said modules.
